(19) United States
(12) Patent Application Publication
(10) Pub. No.: US 2024/0206591 A1
(43) Pub. Date: Jun. 27, 2024

(54) CUSHIONING COMPONENT FOR A WEARABLE ARTICLE

(71) Applicant: NIKE, Inc., Beaverton, OR (US)

(72) Inventors: Patrick Case, Beaverton, OR (US); Scott C. Holt, Portland, OR (US); Dervin A. James, Hillsboro, OR (US)

(73) Assignee: NIKE, Inc., Beaverton, OR (US)

(21) Appl. No.: 18/538,155

(22) Filed: Dec. 13, 2023

Related U.S. Application Data
(60) Provisional application No. 63/435,377, filed on Dec. 27, 2022.

(51) Int. Cl. A43B 13/20; B29D 35/12

(52) U.S. Cl. CPC A43B 13/20; B29D 35/122

(57) ABSTRACT

A cushioning component for a wearable article comprises a bladder including a first barrier sheet and a second barrier sheet that define an interior cavity between opposing inner surfaces of the first barrier sheet and the second barrier sheet and are sealed to one another along a peripheral bond to enclose the interior cavity and retain a gas in the interior cavity. A core includes at least one polymeric sheet disposed in the interior cavity entirely inward of the peripheral bond and traversing the interior cavity between and directly bonded to the opposing inner surfaces of the first and second barrier sheets at a plurality of bonds to tether the first barrier sheet to the second barrier sheet. The at least one polymeric sheet does not create any sealed chambers within the bladder that are not in fluid communication with the interior cavity.

### CROSS-REFERENCE TO RELATED APPLICATION

This application claims the benefit of priority to U.S. Provisional Application No. 63/435,377, filed Dec. 27, 2022 which is incorporated by reference in its entirety.

### TECHNICAL FIELD

The present disclosure generally relates to a cushioning component for a wearable article that includes a bladder and a core of at least one polymeric sheet disposed in the bladder.

### BACKGROUND

Wearable articles, such as articles of footwear, often include cushioning components. Some cushioning components are configured as fluid-filled bladders that enclose an interior cavity to retain a gas in the interior cavity, providing cushioning when loaded.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a perspective view of a polymeric sheet showing a side of the polymeric sheet with blocker ink disposed thereon.

FIG. 2 is a perspective view of an opposing side of the polymeric sheet of FIG. 1 with blocker ink disposed thereon in a different pattern than on the side shown in FIG. 1.

FIG. 3 is a cross-sectional view of a cushioning component including the core of FIG. 2 and a bladder having first and second barrier sheets, with the cushioning component in an uninflated state.

FIG. 4 is a cross-sectional view of the cushioning component of FIG. 3 in an inflated state and taken at lines 4-4 in FIG. 6.

FIG. 5 is a cross-sectional view of the cushioning component of FIG. 4 taken at lines 5-5 in FIG. 4.

FIG. 6 is a perspective view of a side of the cushioning component of FIG. 4.

FIG. 7 is a side view of an alternative embodiment of a cushioning component including a bladder and a core disposed in the bladder having a single polymeric sheet.

FIG. 8 is a perspective view of the cushioning component of FIG. 7.

FIG. 9 is a plan view of the single polymeric sheet of the core of FIG. 7 showing a side of the polymeric sheet with blocker ink disposed thereon.

FIG. 10 is a plan view of an opposing side of the single polymeric sheet of FIG. 9 with blocker ink disposed thereon in a different pattern than on the side shown in FIG. 9.

FIG. 11 is a perspective view of a first side of a first polymeric sheet used in a multi-sheet core showing blocker ink disposed in a first pattern thereon and with an opposite second side not having any blocker ink disposed thereon.

FIG. 12 is a perspective view of a second side of a second polymeric sheet used with the first polymeric sheet of FIG. 11 in the multi-sheet core showing blocker ink disposed thereon in a pattern aligned with the first pattern of the first sheet.

FIG. 13 is a perspective view of the second polymeric sheet of FIG. 12 flipped relative to the position in FIG. 12 to show a first side of the second polymeric sheet with blocker ink disposed thereon in a pattern offset from the first pattern of the first sheet.

FIG. 14 is a perspective view of the first and second polymeric sheets of FIGS. 11 and 13 establishing a core.

FIG. 15 is a cross-sectional view of a cushioning component including the core of FIG. 14, with the cushioning component in an uninflated state.

FIG. 16 is a cross-sectional view of the cushioning component of FIG. 15 in a first inflated state.

FIG. 17 is a cross-sectional view of the cushioning component of FIG. 16 in a second inflated state inflated further than the first inflated state.

FIG. 18 is a perspective view showing the top and lateral side of a cushioning component having a core with multiple polymeric sheets and bond patterns similar to those of the core of FIG. 17.

FIG. 19 is a cross-sectional view of the cushioning component of FIG. 18 taken at lines 19-19 in FIG. 18.

FIG. 20 is a perspective view showing the medial side of the cushioning component of FIG. 18.

FIG. 21 is a perspective view from the rear showing the rear and top of the cushioning component of FIG. 18.

FIG. 22 is a lateral side view of an article of footwear including the cushioning component of FIG. 18.

FIG. 23 is a lateral side view of a sole structure for an article of footwear including a heel cushioning component with a core having multiple polymeric sheets and a bond pattern similar to that of FIG. 17 and including a foam midsole layer overlaying the heel cushioning component.

FIG. 24 is a lateral side view of an article of footwear including the sole structure of FIG. 23.

FIG. 25 is a plan view of an alternative embodiment of a cushioning component including a bladder, a forefoot core disposed in the bladder having at least one polymeric sheet, and a separate heel core disposed in the bladder having at least one polymeric sheet.

FIG. 26 is a plan view of another alternative embodiment of a cushioning component including a bladder, a forefoot core disposed in the bladder having at least one polymeric sheet, and a separate heel core disposed in the bladder having at least one polymeric sheet.

FIG. 27 is a plan view of an alternative embodiment of a cushioning component including a bladder, a forefoot core disposed in the bladder having at least one polymeric sheet, and a separate heel core disposed in the bladder having at least one polymeric sheet.

### DESCRIPTION

The present disclosure generally relates to a wearable article that includes a cushioning component having a bladder and a core disposed in the bladder comprising at least one polymeric sheet, the at least one polymeric sheet bonded to inner sides of barrier sheets of the bladder to act as a tensile component. Providing a tensile component within a bladder may be useful in restraining the bladder when inflated, preventing it from adopting a ball-like shape. A tensile component such as the core according to the present disclosure enables bonding the at least one polymeric sheet to the barrier sheets at bonds having patterns that result in technical advantages both in performance aspects of the cushioning component and ease of manufacturing the cushioning component.

More specifically, a cushioning component for a wearable article comprises a bladder including a first barrier sheet and a second barrier sheet. The first barrier sheet and the second barrier sheet define an interior cavity between opposing inner surfaces of the first barrier sheet and the second barrier sheet and are sealed to one another along a peripheral bond to enclose the interior cavity and retain a gas in the interior cavity. The cushioning component includes a core disposed in the interior cavity such that it is spaced entirely inward of the peripheral bond. The core includes at least one polymeric sheet traversing the interior cavity between and directly bonded to the opposing inner surfaces of the first barrier sheet and the second barrier sheet at a plurality of bonds to tether the first barrier sheet to the second barrier sheet. The at least one polymeric sheet is displaced from the opposing inner surfaces by the gas at unbonded areas of the at least one polymeric sheet. The plurality of bonds are arranged such that the gas in the interior cavity is in fluid communication around the at least one polymeric sheet without the at least one polymeric sheet creating any sealed chambers within the bladder that are not in fluid communication with the interior cavity. In other words, the at least one polymeric sheet does not subdivide the interior cavity into separate, sealed subchambers.

In some implementations, the at least one polymeric sheet is a single polymeric sheet and is bonded to both inner surfaces of the barrier sheets. In other implementations, there are multiple polymeric sheets making up the core. By utilizing blocker ink disposed on the at least one polymeric sheet, the patterns of bonds of the core to the inner surfaces of the barrier sheets (and the bonds of adjacent polymeric sheets in embodiments in which the core includes more than one polymeric sheet) are controlled to determine the final geometry of the completed cushioning component, including height differentials in different regions of an article of footwear, toe spring, etc.

Moreover, utilizing blocker ink enables ease in manufacturing, as blocker ink patterns may be digitally implemented relatively easily in comparison to other tensile components that require specific molds or mold inserts to control bond formation of barrier sheets to internally placed polymeric sheets.

In some implementations, the core includes only a single polymeric sheet that is bonded to the opposing inner surfaces of the first and second barrier sheets. In an example, blocker ink patterns may be linear rows that result in a pattern of bonds providing a zig-zag arrangement of the single polymeric sheet between the barrier sheets. In still other embodiments, the blocker ink patterns result in a pattern of bonds extending outward from a central region in an array.

In other implementations, the core includes multiple polymeric sheets some of which have adjacent sides bonded to one another. The blocker ink patterns may result in a pattern of bonds providing a honeycomb arrangement of the polymeric sheets of the core within the interior cavity.

By disposing the blocker ink so that it extends to an outer perimeter of the core at the inner surfaces of the barrier sheets, and by ensuring that the outer perimeter of the core is entirely inward of the peripheral bond of the barrier sheets, the pattern of bonds of the core does not result in any sealed chambers within the bladder that are not in fluid communication with the interior cavity. In this way, the core itself controls the final geometry of the inflated cushioning component but does not affect the cushioning response of the cushioning component under dynamic loading. Additionally, by utilizing blocker ink, the cushioning component may be relatively flat prior to inflation.

The above features and advantages and other features and advantages of the present teachings are readily apparent from the following detailed description of the modes for carrying out the present teachings when taken in connection with the accompanying drawings. It should be understood that even though in the following Figures embodiments may be separately described, single features thereof may be combined to additional embodiments.

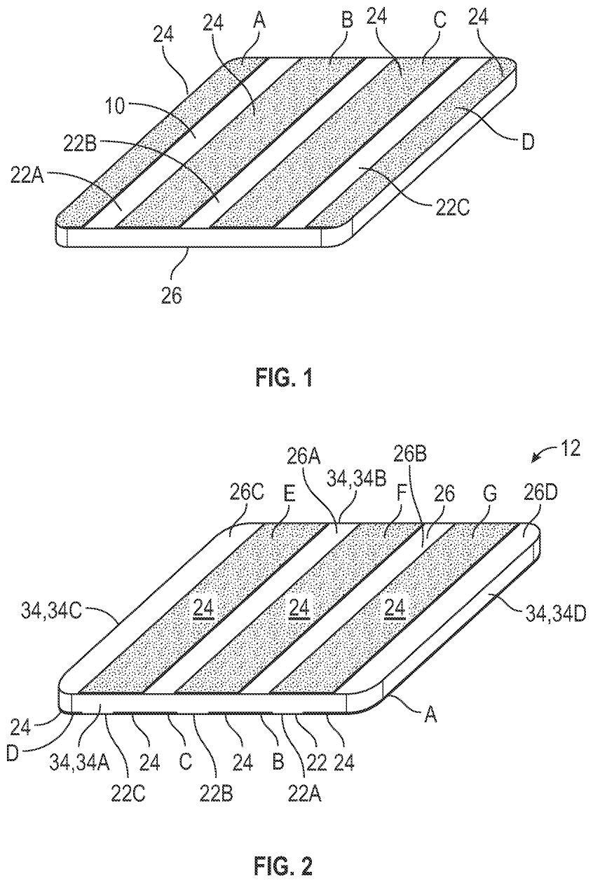

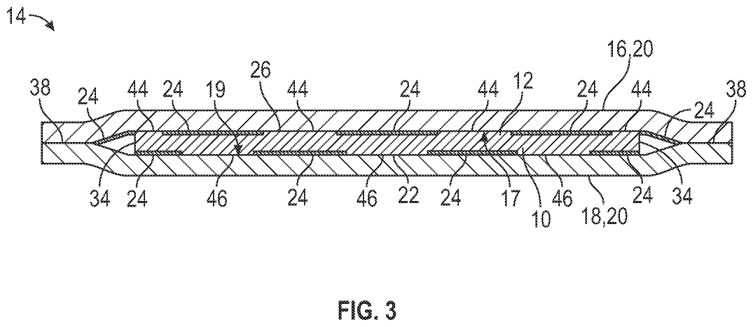

FIG. 1 is a perspective view of a polymeric sheet 10 included in a core 12 of a cushioning component 14 shown in FIGS. 3-6. The core 12 is bonded to first and second barrier sheets 16, 18, that form a bladder 20 defining an interior cavity 21 between opposing inner surfaces of the first and second barrier sheets 16, 18 (e.g., between inner surface 17 of the first barrier sheet 16 and inner surface 19 of the second barrier sheet 18). The polymeric sheet 10 is a single polymeric sheet and is the only polymeric sheet included in the core 12. Although the polymeric sheet 10 is a single polymeric sheet, in some examples, it may be comprised of multiple layers of materials, as discussed herein.

FIG. 1 shows a side 22 of the polymeric sheet 10. The side 22 is referred to herein as a second side. Blocker ink 24 is disposed on the second side 22 of the polymeric sheet 10 in a pattern of linear and parallel rows, including row A, row B, row C, and row D. The blocker ink 24 may be disposed on the sheet 10 via a computer-controlled printer head or heads (not shown) according to a stored algorithm representing a predetermined printing pattern. The printed pattern of rows A-D is referred to herein as a second predetermined pattern.

As used herein, blocker ink may also be referred to as anti-weld ink or anti-weld material and may be printed according to a different predetermined programmed pattern for each side 22, 26 of the polymeric sheet 10 at all selected locations where bonds of the polymeric sheet 10 to barrier sheets 16, 18, described herein, are not desired. When bonded to one another such as by thermal processing, the stacked, flat polymeric sheet 10 and barrier sheets 16, 18 create bonds between adjacent sheets on all adjacent sheet surfaces except where the blocker ink is disposed. Accordingly, the patterns of blocker ink determine corresponding patterns of resulting bonds in the finished cushioning component 14.

FIG. 2 shows blocker ink 24 disposed on an opposite side 26 (referred to herein as a first side 26) in a different predetermined pattern (referred to as a first predetermined pattern) than on the second side 22. Specifically, the first predetermined pattern shown in FIG. 2 is a pattern of linear and parallel rows, including row E, row F, and row G.

It is apparent from FIGS. 1 and 2 that the rows A, B, C, and D of the second predetermined pattern on the second side 22 are at least partially offset from and overlap the rows E, F, and G of the first predetermined pattern on the first side 26. In this arrangement, area 26A between rows E and F on the first side 26 is directly opposed to (directly overlies) row C of blocker ink 24 on the second side 22. Area 26B between rows F and G on the first side 26 is directly opposed to (directly overlies) row B of blocker ink 24 on the second side 22. Similarly, area 22A between rows A and B on the second side 22 is directly opposed to (directly underlies) row G of blocker ink 24 on the first side 26. Area 22B between rows B and C on the second side 22 is directly opposed to (directly underlies) row F of blocker ink 24 on the first side 26. Area 22C between rows C and D on the second side 22 is directly opposed to (directly underlies) row E of blocker ink 24 on the first side 26. The areas of the first side 26 and of the second side 22 on which the blocker ink 24 is disposed (e.g., the areas at rows A, B, C, D, E, F, and G) will become the only unbonded areas of the core 12 in FIG. 8 (e.g., the only areas of the core 12 facing the inner surfaces 17, 19 of the barrier sheets 16 and 18 that are not bonded to the barrier sheets 16, 18).

A width of each of the areas 22A, 22B, and 22C between the adjacent rows of blocker ink 24 on the second side 22 is less than a width of each of the rows E, F, and G of blocker ink 24 on the first side 26. Similarly, a width of each of the areas 26A and 26B between the adjacent rows of blocker ink 24 on the first side 26 is less than a width of each of the rows B and C of blocker ink 24 on the second side 22. A width of each of end areas 26D and 26C is less than a width of respective rows A and D of blocker ink 24. With this arrangement, no portion of any of the areas 22A, 22B, and 22C is opposed by a portion of the first side 26 that is not covered with blocker ink 24 and no portion of any of the areas 26A, 26B, 26C, and 26D is opposed by a portion of the second side 22 that is not covered with blocker ink 24.

As shown in FIG. 2, the blocker ink 24 extends to an outer perimeter 34 of the core 12 both at the first side 26 of the polymeric sheet 10 and the second side 22 of the polymeric sheet 10. Specifically, each of the rows A, B, C, D, E, F, and G extends from a first edge 34A to an opposite second edge 34B of the outer perimeter 34 along a width of the core 12. Row D extends along the entire edge 34C of the outer perimeter 34 and row A extends along the entire opposite edge 34D of the outer perimeter 34.

This placement of the patterns of the blocker ink 24 relative to the outer perimeter 34 as well as placing the core 12 so that the entire outer perimeter 34 is entirely inward of a peripheral bond 38 at which the first barrier sheet 16 is bonded to the second barrier sheet 18 ensures that the core 12 will tether the first and second barrier sheets 16 and 18 without creating any sealed chambers that are not in fluid communication with the interior cavity 21 defined between the opposing inner surfaces 17, 19 of the barrier sheets 16, 18. The core 12 will thus collapse to return toward the flat state under dynamic compressive loading of the cushioning component 14 and acts as a tether to control and vary the distance between the respective inner surfaces 17, 19 of the barrier sheets 16, 18 without affecting the ability of the bladder 20 to compress under loading.

Traditional tensile components may include a first polymeric sheet bonded only to the inner surface of the first barrier sheet, a second polymeric sheet bonded only to the inner surface of the second barrier sheet, and a plurality of tethers extending from the first polymeric sheet to the second polymeric sheet. Due to this configuration, such traditional tensile components are not relatively flat or sheet-like prior to inflating the interior cavity of a bladder in which they are disposed and are not amendable to heat pressing either to create a core of multiple polymeric sheets or to bond a core of a single polymeric sheet or multiple polymeric sheets to the inner surfaces of the barrier sheets.

The barrier sheets 16, 18 of the bladder 20 can be formed from a variety of materials including various polymers that can resiliently retain a fluid such as air or another gas. The polymeric sheet 10 may be formed of the same material or materials as the barrier sheets 16, 18 as described herein, or may be formed of a polymeric material that does not necessarily retain fluid, as, unlike the barrier sheets 16, 18, the polymeric sheet 10 functions as a tether but does not seal any interior cavity as do the barrier sheets 16, 18. Examples of polymer materials for the barrier sheets 16, 18 and the polymeric sheet 10 can include thermoplastic urethane, polyurethane, polyester, polyester polyurethane, and polyether polyurethane. Moreover, the barrier sheets 16, 18 and the polymeric sheet 10 can be formed of layers of different materials. In one embodiment, the barrier sheets 16, 18 and/or the polymeric sheet 10 is formed from thin films having one or more thermoplastic polyurethane layers with one or more barrier layers of a copolymer of ethylene and vinyl alcohol (EVOH) that is impermeable to the pressurized fluid contained therein as disclosed in U.S. Pat. No. 6,082,025, which is incorporated by reference in its entirety. The barrier sheets 16, 18 and the polymeric sheet 10 may also be formed from a material that includes alternating layers of thermoplastic polyurethane and ethylene-vinyl alcohol copolymer, as disclosed in U.S. Pat. Nos. 5,713,141 and 5,952,065 to Mitchell et al. which are incorporated by reference in their entireties. Alternatively, the layers may include ethylene-vinyl alcohol copolymer, thermoplastic polyurethane, and a regrind material of the ethylene-vinyl alcohol copolymer and thermoplastic polyurethane. The barrier sheets 16, 18 and the polymeric sheet 10 May also be a flexible microlayer membrane that includes alternating layers of a gas barrier material and an elastomeric material, as disclosed in U.S. Pat. Nos. 6,082,025 and 6,127,026 to Bonk et al. which are incorporated by reference in their entireties. Additional suitable materials for the barrier sheets 16, 18 and the polymeric sheet 10 are disclosed in U.S. Pat. Nos. 4,183,156 and 4,219,945 to Rudy which are incorporated by reference in their entireties. Further suitable materials for the barrier sheets 16, 18 and the polymeric sheet 10 include thermoplastic films containing a crystalline material, as disclosed in U.S. Pat. Nos. 4,936,029 and 5,042,176 to Rudy, and polyurethane including a polyester polyol, as disclosed in U.S. Pat. Nos. 6,013,340, 6,203,868, and 6,321,465 to Bonk et al. which are incorporated by reference in their entireties. In selecting materials for the barrier sheets 16, 18 and the polymeric sheet 10, engineering properties such as tensile strength, stretch properties, fatigue characteristics, dynamic modulus, and loss tangent can be considered. The thickness of the barrier sheets 16, 18 and the polymeric sheet 10 can be selected to provide these characteristics.

FIG. 3 is a cross-sectional view of the cushioning component 14. As can be seen in FIG. 3, the first predetermined pattern of the blocker ink 24 on the first side 26 of the polymeric sheet 10 is disposed against the inner surface 17 of the first barrier sheet 16, and the second predetermined pattern of the blocker ink 24 on the second side 22 of the polymeric sheet 10 is disposed against the inner surface 19 of the second barrier sheet 18. Portions of one or both of the inner surfaces 17, 19 that are outward of the outer perimeter of the core 12 and inward of where the peripheral bond 38 is formed may also be preprinted with blocker ink 24 or otherwise processed so that these portions of the inner surfaces 17, 19 will not bond to one another.

A first pattern of bonds 44 is formed at the interfacing areas of the first side 26 of the polymeric sheet 10 and the inner surface 17 of the first barrier sheet 16 (e.g., where there is not blocker ink 24 between the first side 26 and the inner surface 17). A second pattern of bonds 46 is formed at the interfacing areas of the second side 22 of the polymeric sheet 10 and the inner surface 19 of the second barrier sheet 18 (e.g., where there is not blocker ink 24 between the second side 22 and the inner surface 19). The blocker ink 24 prevents bonding at any interfacing areas where it is disposed. As can be seen in FIG. 3, the core 12 lays flat within the bladder 20 with the unbonded areas (areas at blocker ink 24) contacting the opposing inner surfaces 17, 19 when the interior cavity 21 of the bladder 20 is uninflated.

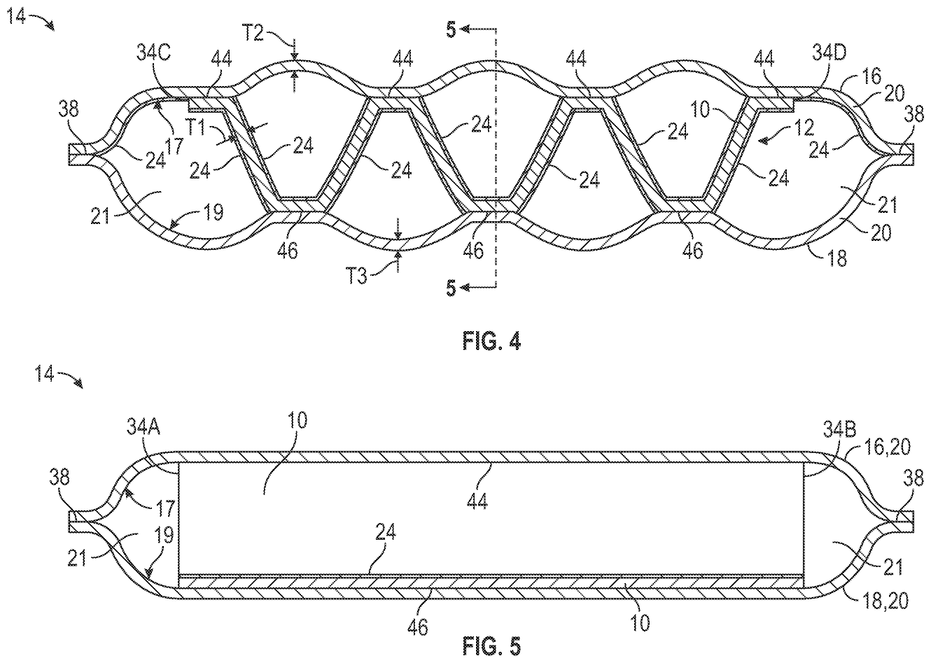

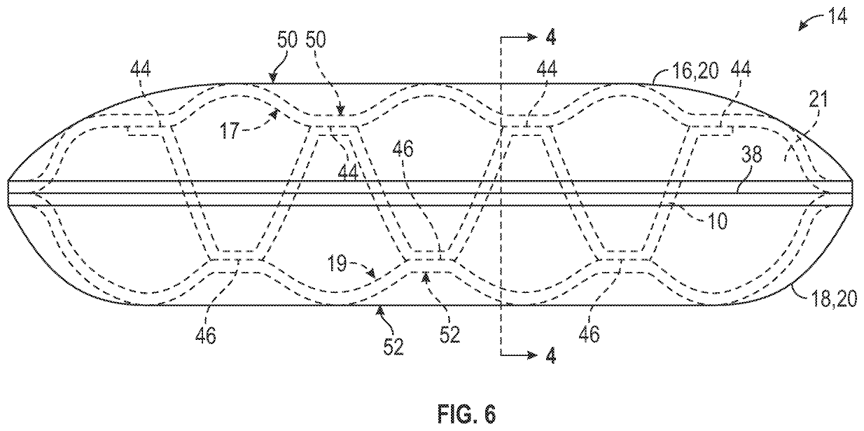

FIG. 4 is a cross-sectional view of the cushioning component 14 of FIG. 3 in an inflated state and taken at lines 4-4 in FIG. 6. Inflating the interior cavity 21 with the gas causes the polymeric sheet 10 to be tensioned between the barrier sheets 16, 18 and move from the relatively flat state of FIG. 3 to the relatively extended state of FIG. 8. A small portion of the peripheral bond 38 may initially be left open to permit inflation of the interior cavity 21 with gas, such as air or nitrogen, and then may be sealed after inflation to completely enclose the interior cavity 21, retaining the gas in the interior cavity, or a fill tube may extend through the peripheral bond 38 that may then be plugged after inflation, as is understood by those skilled in the art.

FIG. 5 is a cross-sectional view of the cushioning component of FIG. 4 taken at lines 5-5 in FIG. 4. As can be seen best in FIGS. 4 and 5, the core 12 is disposed in the interior cavity 21 and is spaced entirely inward of the peripheral bond 38. The four edges 34A, 34B, 34C, and 34D of the outer perimeter 34 of the core 12 are shown entirely inward of the peripheral bond 38. In the relatively extended state of FIG. 4, the core 12 and, more specifically, the polymeric sheet 10, traverses the interior cavity 21 between and is directly bonded to the opposing inner surfaces 17, 19 of the first barrier sheet 16 and the second barrier sheet 18 at a plurality of bonds 44, 46 to tether the first barrier sheet 16 to the second barrier sheet 18.

The polymeric sheet 10 is displaced from the opposing inner surfaces 17, 19 by the gas at unbonded areas (areas where blocker ink 24 is initially disposed) of the polymeric sheet 10. The bonds 44, 46 are arranged in patterns (e.g., the first pattern of bonds 44 at the first barrier sheet 16 and the second pattern of bonds 46 at the second barrier sheet 18) such that the gas in the interior cavity 21 is in fluid communication around the polymeric sheet 10 without the polymeric sheet 10 creating any sealed chambers within the bladder 20 that are not in fluid communication with the interior cavity 21.

More specifically, because each of the rows of the blocker ink 24 extends to the outer perimeter 34 of the core 12 at the inner surface 17 of the first barrier sheet 16 (e.g., rows E, F, and G) or at the inner surface 19 of the second barrier sheet 18 (e.g., rows A, B, C, and D) there are no unbonded portions of the polymeric sheet 10 that are not open to the outer perimeter 34 and therefore none are cut off from fluid communication with the gas in the interior cavity 21. The second set of bonds 46 is offset from the first set of bonds 44 such that bonds 46 of the second set alternate with bonds 44 of the first set along the length of the single polymeric sheet 10 of the core 12, as shown in FIG. 4, where the length is considered to be the direction from the edge 34C to the edge 34D of the polymeric sheet 10. Because the first set of bonds 44 are at the areas 26A, 26B, 26C, and 26D, the bonds 46 are linear bonds arranged in rows. Because the second set of bonds 46 are at the areas 22A, 22B, and 22C, the bonds 46 are also linear bonds arranged in rows.

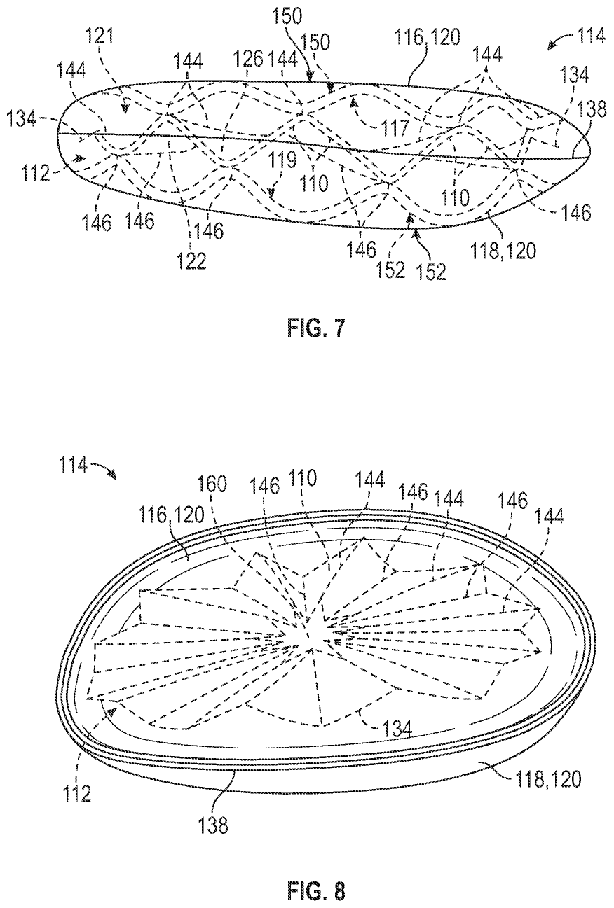

As is apparent in FIGS. 3-4, a thickness T1 of the polymeric sheet 10 is not greater than a thickness T2 of the first barrier sheet 16 and is not greater than a thickness T3 of the second barrier sheet 18. Maintaining a sheet thickness of the polymeric sheet 10 not greater than that of the barrier sheets 16 and 18 helps to ensure the flexibility of the core 12 to function as a tether that collapses back toward the relatively flat state of FIG. 7 easily under compressive loading.

FIG. 6 shows that the tension created in the polymeric sheet 10 by the inflation of the interior cavity 21 causes portions of the first barrier sheet 16 inward of the outer perimeter 34 of the core 12 to be pulled downward at the bonds 44, as indicated by the contoured exterior surface 50 of the first barrier sheet 16. Because the outer perimeter 34 of the core 12 is entirely inward of the peripheral bond 38, the barrier sheets 16, 18 will not be tethered together at a peripheral portion of the interior cavity 21 outward of the outer perimeter 34 of the core 12 and inward of the peripheral bond 38. The distance between the inner surfaces 17 and 19 and the resulting height of the cushioning component 14 may thus be greatest outward of the core 12. The top exterior surface 50 is represented with hidden lines where the first barrier sheet 16 is pulled downward by polymeric sheet 10 at the bonds 44.

Similarly, tension created in the polymeric sheet 10 by the inflation of the interior cavity 21 causes portions of the second barrier sheet 18 inward of the outer perimeter 34 of the core 12 to be pulled upward at the bonds 46, as indicated by the contoured exterior surface 52 of the second barrier sheet 18. The pattern of blocker ink 24 printed on the polymeric sheet 10 and the resulting patterns of bonds 44, 46 of the polymeric sheet 10 of the core 12 to the barrier sheets 16, 18 can be selected to control the resulting contours of the exterior surfaces 50, 52 of the barrier sheets 16, 18.

FIG. 7 is a side view of an alternative embodiment of a cushioning component 114 including a bladder 120 comprising a first barrier sheet 116 and a second barrier sheet 118 bonded to one another at a peripheral bond 138 to enclose an interior cavity 121 and retain a gas in the interior cavity 121. The cushioning component 114 includes a core 112 disposed within the interior cavity 121 of the bladder 120. The core 112 is a single polymeric sheet 110. The first barrier sheet 116, second barrier sheet 118, and the polymeric sheet 110 may comprise the same materials and have the same properties as described with respect to the corresponding first barrier sheet 16, second barrier sheet 18, and polymeric sheet 10 of the cushioning component 14.

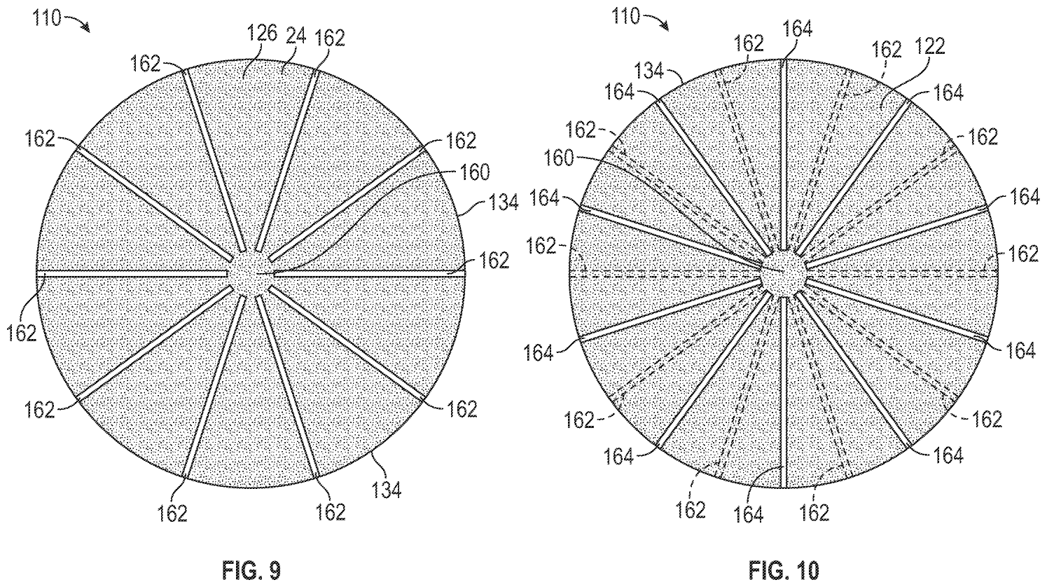

The polymeric sheet 110 traverses the interior cavity 121 between and is directly bonded to the inner surface 117 of the first barrier sheet 116 and to the opposing inner surface 119 of the second barrier sheet 118 at a plurality of bonds 144, 146 to tether the first barrier sheet 116 to the second barrier sheet 118. The bonds 144 bond a first side 126 of the polymeric sheet 110 to the inner surface 117 of the first barrier sheet 116. The bonds 146 bond a second side 122 of the polymeric sheet 110 to the inner surface 119 of the second barrier sheet 118. The polymeric sheet 110 is displaced from the opposing inner surfaces 117, 119 by the gas at unbonded areas of the polymeric sheet 110 (all areas where blocker ink 24 is printed as shown in FIGS. 9 and 10). The unbonded areas correspond with the patterns of blocker ink 24 printed on the first and second sides 126, 122 of the polymeric sheet 110, as discussed with respect to FIGS. 9 and 10. Portions of one or both of the inner surfaces 117, 119 of the barrier sheets 116, 118 that are outward of the outer perimeter 134 of the core 112 and inward of the peripheral bond 138 may also be printed with blocker ink 24 or otherwise processed so that these portions of the inner surfaces 117, 119 will not bond to one another.

The tension created in the polymeric sheet 110 by the inflation of the interior cavity 121 causes a top exterior surface 150 of the first barrier sheet 116 inward of the peripheral bond 138 to be pulled downward at the bonds 144. Similarly, tension created in the polymeric sheet 110 by the inflation of the interior cavity 121 causes a bottom exterior surface 152 of the second barrier sheet 118 inward of the peripheral bond 138 to be pulled upward at the bonds 146. The patterns of blocker ink printed 24 on the polymeric sheet 110 and the resulting patterns of bonds 144, 146 of the polymeric sheet 110 of the core 112 to the barrier sheets 116, 118 can be selected to control the resulting contours of the exterior surfaces 150, 152 of the barrier sheets 116, 118.

Because the outer perimeter 134 of the polymeric sheet 110 is entirely inward of the peripheral bond 138 between the barrier sheets 116, 118, and because the plurality of bonds 144, 146 are arranged in patterns specifically determined by the predetermined patterns of blocker ink 24 on the first and second sides 126, 122 of the polymeric sheet 110 (as described with respect to FIGS. 9 and 10), the gas in the interior cavity 121 is in fluid communication around the polymeric sheet 110 without the polymeric sheet 110 creating any sealed chambers within the bladder 120 that are not in fluid communication with the interior cavity 121. In other words, the polymeric sheet 110 does not subdivide the interior cavity 121 into separate, sealed subchambers.

The first set of bonds 144 and the second set of bonds 146 begin at an outer extent of a central region 160 and extend outward from the central region 160 of the single polymeric sheet 110 to the outer perimeter 134 of the polymeric sheet 110 in an array. The bonds 144 of the first set alternate with the bonds 146 of the second set around the central region 160, as best shown in FIG. 8 (only some of the bonds are labelled in FIG. 8) and as would be apparent based on the first and second predetermined patterns of blocker ink 24 on the first and second sides 126, 122 of the polymeric sheet 110 shown and described in FIGS. 9 and 10. The bonds 144, 146 result in an accordion-like, tented structure of the polymeric sheet 110 fanning outward from the central region 160. The central region 160 is not bonded to either of the first barrier sheet 116 or the second barrier sheet 118. Fluid in the portion of the interior cavity outward of the outer perimeter 134 is thus in fluid communication with portions inward of the outer perimeter 134 between the first barrier sheet 116 and the polymeric sheet 110 (e.g., over the first side 126 in FIG. 7) between any and all adjacent pairs of the first bonds 144 and the central region 160, for example. Fluid in the portion of the interior cavity 121 outward of the outer perimeter 134 is thus also in fluid communication with portions inward of the outer perimeter 134 between the second barrier sheet 118 and the polymeric sheet 110 (e.g., under the second side 122 in FIG. 7) between any and all adjacent pairs of the second bonds 146 and the central region 160, for example.

FIG. 9 is a plan view of the single polymeric sheet 110 of the core 112 of the cushioning component 114 of FIG. 7 showing the first side 126 of the polymeric sheet 110 with blocker ink 24 printed thereon prior to bonding to the first barrier sheet 116. FIG. 10 is a plan view of the opposing second side 122 of the single polymeric sheet 110 with blocker ink 24 printed thereon prior to bonding to the second barrier sheet 118. As shown, the blocker ink 24 extends to the outer perimeter 134 of the polymeric sheet 110 at both sides 126, 122. The first predetermined pattern of blocker ink 24 printed on the first side 126 includes all areas except for equally spaced linear strips 162 extending in an array outward from a central region 160. The central region is covered with blocker ink 24. The strips 162 that have no blocker ink 24 thereon become the areas at the bonds 144 where the polymeric sheet 110 is bonded to the first barrier sheet 116 such as by thermal bonding after thermal processing is carried out to produce cushioning component 114.

Blocker ink 24 is also printed on the second side 122 in a different predetermined pattern (referred to as a second predetermined pattern) than on the first side 126. The second predetermined pattern of blocker ink 24 printed on the second side 122 includes all areas except for equally spaced linear strips 164 extending in an array outward from the central region 160 on the second side 122. The strips 164 that have no blocker ink 24 thereon become the areas at the bonds 146 where the polymeric sheet 110 is bonded to the second barrier sheet 118 after thermal processing is carried out to produce cushioning component 114. In FIG. 10, the locations of the strips 162 on the opposite side 126 are indicated with dashed lines to show that they are offset from the locations of the strips 164. Stated differently, the strips 162 and the strips 164 extend radially outward from the central region 160 in an array, with each strip 162 falling between an adjacent pair of the strips 164 but on an opposite side of the polymeric sheet 110.

Like the core 12, the core 112 lies relatively flat along with the barrier sheets 116, 118 prior to inflation of the interior cavity 121. The core 112 becomes tensioned to tether the barrier sheets 116, 118 to one another when inflated. Because the bonds 144 and 146 are linear bonds arranged to extend radially outward, the distance between adjacent bonds is greater at the outer perimeter 34 than at the central region 160. When the interior cavity 121 is inflated, this configuration of the bonds 144, 146 causes the distance between the first barrier sheet 116 and the second barrier sheet 118 to be less at the central region 160 than at the outer perimeter 134 of the core 112, with the distance between the sheets 116, 118 increasing linearly in the outward direction. The cushioning component 114 thus has greater height at the outer perimeter 134 than at the central region 160 and appears to be centrally depressed at both the exterior of the first barrier sheet 116 and the exterior of the second barrier sheet 118.

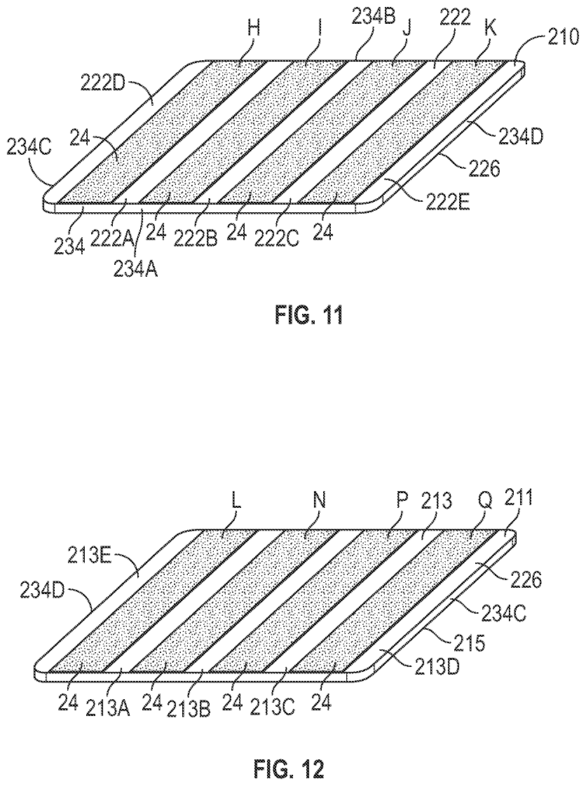

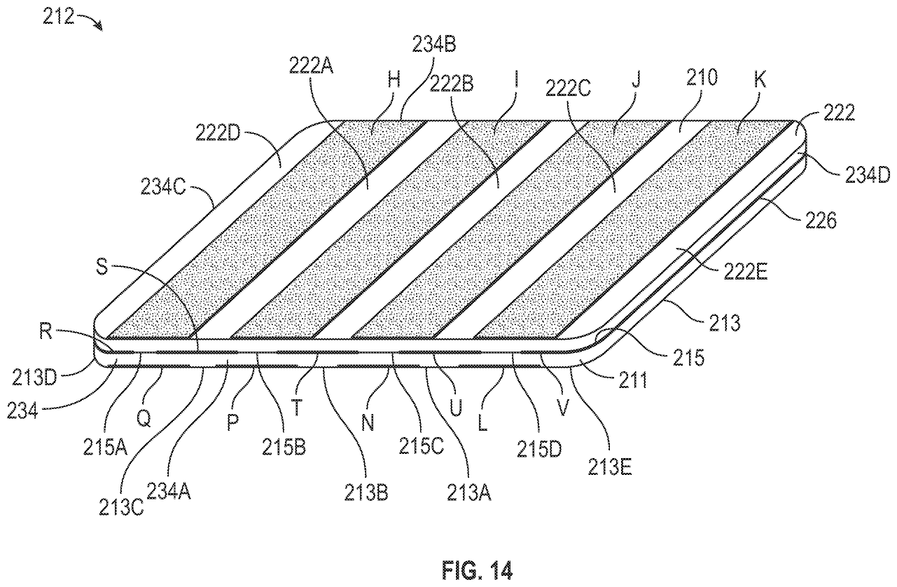

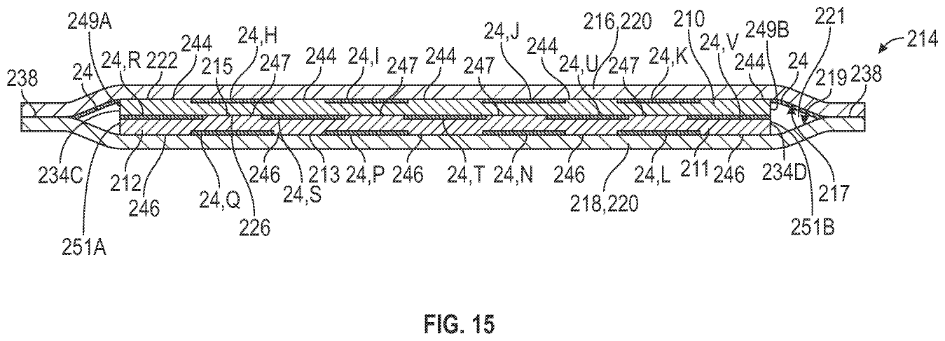

FIGS. 11-13 show polymeric sheets 210, 211 used to form a core 212 shown in FIG. 14. The core 212 is included in a cushioning component 214 shown in FIGS. 15-17. FIG. 11 is a perspective view of a polymeric sheet 210 included in the core 212 and is referred to herein as a first polymeric sheet 210. FIG. 12 is a perspective view of another polymeric sheet 211 included in the core 212 and is referred to herein as a second polymeric sheet 211. The core 212 is bonded to first and second barrier sheets 216, 218 that form a bladder 220 defining an interior cavity 221 between opposing inner surfaces of the first and second barrier sheets 216, 218 (e.g., between inner surface 217 of the first barrier sheet 216 and inner surface 219 of the second barrier sheet 218). The first barrier sheet 216, the second barrier sheet 218, and the polymeric sheets 210 and 211 may comprise the same materials and have the same properties as described with respect to the corresponding first barrier sheet 16, second barrier sheet 18, and polymeric sheet 10.

FIG. 11 shows a first side 222 of the first polymeric sheet 210. Blocker ink 24 is disposed on the first side 222 of the first polymeric sheet 210 in a pattern of linear and parallel rows, including row H, row I, row J, and row K. The blocker ink 24 may be disposed on the first polymeric sheet 210 via a computer-controlled printer head or heads (not shown) according to a stored algorithm representing a predetermined printing pattern. For purposes of discussion of the core 212, the printed pattern of rows H-K is referred to herein as a first predetermined pattern. The opposite second side 226 of the first polymeric sheet 210 has no blocker ink printed thereon.

The first polymeric sheet 210 has area 222A between rows H and I, area 222B between rows I and J, and area 222C between rows J and K. Area 222D is between row H and edge 234C of the outer perimeter 234 of the core 212. Area 222E is between row K and edge 234D of the outer perimeter 234 of the core. Adjacent rows H and I, adjacent rows I and J, and adjacent rows J and K are spaced equal distances apart from one another so that each of the areas 222A, 222B, and 222C is of an equal size. No blocker ink 24 is disposed on areas 222A, 222B, 222C, 222D, and 222E.

FIG. 12 shows a second side 213 of the second polymeric sheet 211 with blocker ink 24 printed thereon in a pattern of linear and parallel rows, including row L, row N, row P, and row Q. The pattern of rows L, N, P, and Q is referred to herein as a second predetermined pattern for purposes of discussion of the core 212. The second predetermined pattern is the same as the first predetermined pattern in that the rows L, N, P, and Q are each of an equal width that is the same width as each of rows L, N, P, and Q and adjacent rows of the second predetermined pattern are spaced apart from one another by the same amount as the adjacent rows H, I, J, and K of the first predetermined pattern.

The second polymeric sheet 211 has area 213A between rows L and N, area 213B between rows N and P, and area 213C between rows P and Q. Area 213D is between row Q and edge 234C of the outer perimeter 234 of the core 212. Area 213E is between row L and edge 234D of the outer perimeter 234 of the core 212. Adjacent rows L and N, adjacent rows N and P, and adjacent rows P and Q are spaced equal distances apart from one another so that each of the areas 213A, 213B, and 213C is of an equal size that is the same size as each of the areas 222A, 222B, and 222C. No blocker ink 24 is disposed on areas 213A, 213B, 213C, 213D, and 213E.

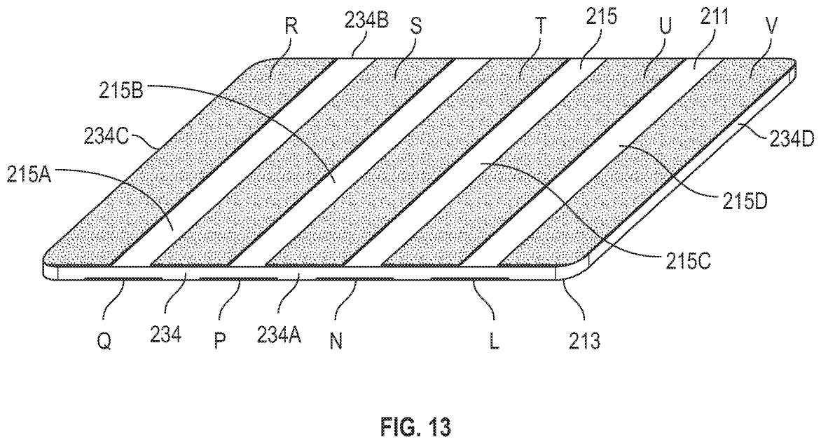

In FIG. 13, the first side 215 is shown (e.g., faces upward) while the second side 213 faces downward, with its rows L, N, Q, and P shown already disposed thereon. Blocker ink 24 is disposed on the first side 215 of the second polymeric sheet 211 in a third predetermined pattern. Specifically, the third predetermined pattern is a pattern of linear and parallel rows R, S, T, U, and V. It is apparent from FIG. 13 that the rows R, S, T, U, and V on the first side 215 are at least partially offset from and overlap the rows L, N, P and Q of the second predetermined pattern on the second side 213. The rows R, S, T, U, and V are also at least partially offset from and overlap the rows H, I, J and K on the first side 222 of the first polymeric sheet 210 (where overlap means that at least part of a row falls directly above or directly below at least part of a row that it overlaps when the polymeric sheets 210, 211 are stacked together as shown in FIG. 14). The third predetermined pattern is thus said to be offset from both the first predetermined pattern of the first side 222 of the first polymeric sheet 210 and the second predetermined pattern of the second side 213 of the second polymeric sheet 211.

Referring again to FIG. 13, the second polymeric sheet 211 has area 215A between rows R and S, area 215B between rows S and T, area 215C between rows T and U, and area 215D between rows U and V. Adjacent rows R and S, adjacent rows S and T, adjacent rows T and U, and adjacent rows U and V are spaced equal distances apart from one another so that each of the areas 215A, 215B, 215C, and 215D is of an equal size, which may be the same size as each of the areas 222A, 222B, and 222C and as each of the areas 213A, 213B, and 213C. No blocker ink 24 is disposed on areas 215A, 215B, 215C, and 215D.

FIG. 14 is a perspective view of the first and second polymeric sheets 210, 211 stacked together with the areas 215A, 215B, 215C, and 215D of the first side 215 of the second polymeric sheet 211 against the second side 226 of the first polymeric sheet 210. The first polymeric sheet 210 is disposed between the first barrier sheet 216 and the second polymeric sheet 211 in FIG. 15. The second polymeric sheet 211 is disposed between the first polymeric sheet 210 and the second barrier sheet 218 such that the first side 222 of the first polymeric sheet 210 faces and abuts the first inner surface 217 of the first barrier sheet 216, the second side 226 of the first polymeric sheet 210 faces and abuts the first side 215 of the second polymeric sheet 211, and the second side 213 of the second polymeric sheet 211 faces and abuts the first inner surface 219 of the second barrier sheet 218. The rows H, I, J, and K as well as the rows R, S, T, U, V and the rows L, N, P, and Q all extend from a front edge 234A of the outer perimeter 234 to a rear edge 234B of the outer perimeter. The row R extends along and to the side edge 234C. The row V extends along and to the side edge 234D.

The barrier sheets 216, 218 and the core 212 are subjected to thermal processing so that the first side 222 of the first polymeric sheet 210 is directly bonded to the first inner surface 217 of the first barrier sheet 216 at a first set of bonds 244 of the plurality of bonds, the second side 213 of the second polymeric sheet 211 is directly bonded to the first inner surface 219 of the second barrier sheet 218 at a second set of bonds 246 of the plurality of bonds, the second side 226 of the first polymeric sheet 210 is bonded to the first side 215 of the second polymeric sheet 211 at a third set of bonds 247 of the plurality of bonds. The bonds of the third set of bonds 247 alternate with the bonds of the first set of bonds 244 along a length of the first polymeric sheet 210 (the length being between the first end 249A and the second end 249B of the first polymeric sheet 210 in FIG. 15). The bonds of the third set of bonds 247 alternate with the bonds of the second set of bonds 246 along a length of the second polymeric sheet 211 (the length begin between the first end 251A and the second end 251B of the second sheet 211 in FIG. 15). The second set of bonds 246 is aligned with the first set of bonds 244 and offset from the third set of bonds 247.

The core 212 is spaced entirely inward of the peripheral bond 238. Stated differently, the four edges 234A, 234B, 234C, and 234D of the outer perimeter 234 of the core 212 are entirely inward of the peripheral bond 238. As shown in FIG. 15, portions of one or both of the inner surfaces 217, 219 that are outward of the outer perimeter 234 of the core 212 and inward of where the peripheral bond 238 is formed between the first and second polymeric sheets 210, 211 may also have blocker ink 24 disposed thereon so that these portions of the inner surfaces 217, 219 will not bond to one another.

FIG. 15 is a cross-sectional view of the cushioning component 214 in an uninflated state. The core 212 is positioned in the interior cavity 221. As can be seen in FIG. 15, the core 212 lays flat within the bladder 220 with the unbonded areas of the first predetermined pattern at rows H, I, J, and K (areas at blocker ink 24) of the first side 222 of the first polymeric sheet 210 and the unbonded areas of the second predetermined pattern at rows L, N, P, and Q (areas at blocker ink 24) of the second side 213 of the second polymeric sheet 211 contacting the respective opposing inner surfaces 217, 219 when the interior cavity 21 of the bladder 220 is uninflated. The unbonded areas of the third predetermined pattern at rows R, S, T, U and V (areas at the rows of blocker ink 24) of the first side 215 of the second polymeric sheet 211 contact the second side 226 of the first polymeric sheet 210 when the interior cavity 21 of the bladder 220 is uninflated.

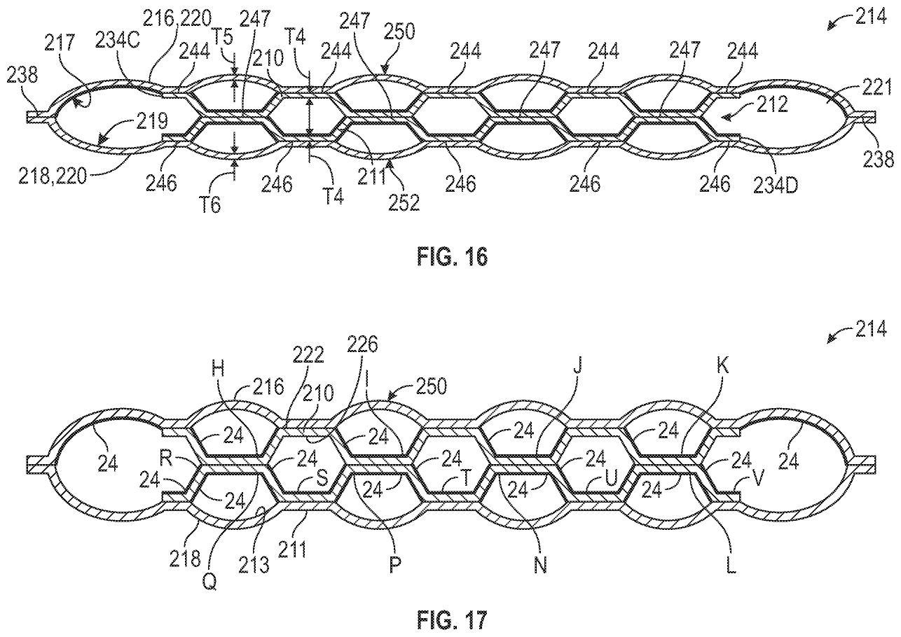

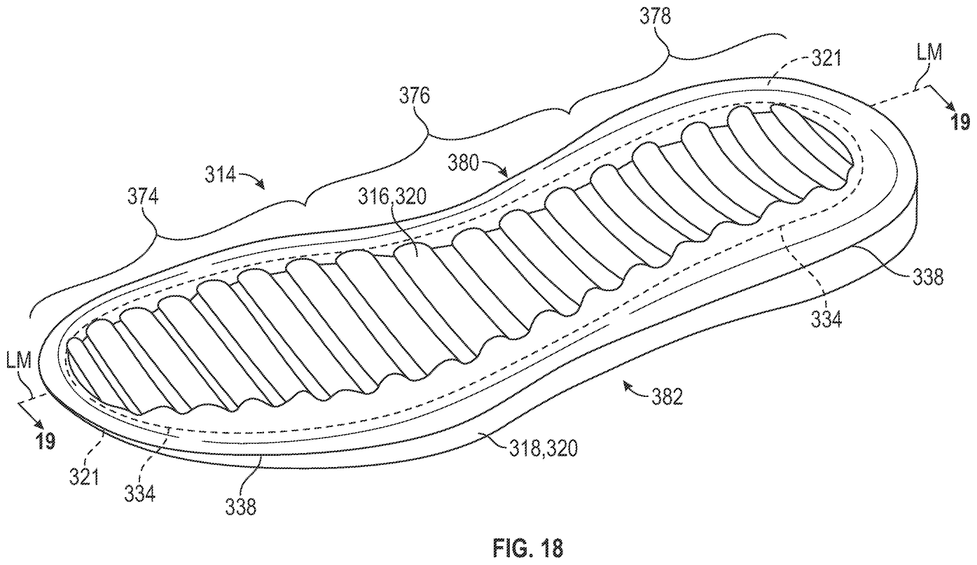

FIG. 16 is a cross-sectional view of the cushioning component 214 of FIG. 15 in a first inflated state. FIG. 17 is a cross-sectional view of the cushioning component 214 of FIG. 15 in a second inflated state in which the cushioning component 214 is inflated further than the first inflated state.

In the relatively extended states (e.g., in any of the inflated states of FIGS. 16 and 17), the core 212 is relatively extended in comparison to the uninflated state. The core 212 traverses the interior cavity 221 between and is directly bonded to the opposing inner surfaces 217, 219 of the first barrier sheet 216 and the second barrier sheet 218 at the first set of bonds 244 and the second set of bonds 246 and with the third set of bonds 247 tethering the first polymeric sheet 210 to the second polymeric sheet 211.

The polymeric sheets 210 and 211 are displaced from the opposing inner surfaces 217, 219 by the gas at unbonded areas (at rows H, I, J, and K of FIG. 11 where blocker ink 24 is initially disposed) of the first side 222 of the first polymeric sheet 210 and at unbonded areas (rows L, N, P, and Q of FIG. 12 where blocker ink 24 is initially disposed) of the second side 213 of the second polymeric sheet 211. The second side 226 of the first polymeric sheet 210 is displaced from the first side 215 of the second polymeric sheet 211 at unbonded areas (rows R, S, T, U, and V where blocker ink 24 is initially disposed). The plurality of bonds 244, 246, and 247 are arranged in a pattern (e.g., the first pattern of bonds 244 at the first barrier sheet 216, the second pattern of bonds 246 at the second barrier sheet 218, and the third pattern of bonds 247 between the first and second polymeric sheets 210, 211) such that the gas in the interior cavity 221 is in fluid communication around the polymeric sheets 210 and 211 without either of the polymeric sheets 210 and 211 creating any sealed chambers within the bladder 220 that are not in fluid communication with the interior cavity 221.

More specifically, because each of the rows H, I, J, and K of the blocker ink 24 extends to the opposite edges 234A, 234B of the outer perimeter 234 of the core 212 at the inner surface 217 of the first barrier sheet 216, each of the rows L, N, P, and Q extends to the opposite edges 234A, 234B of the outer perimeter 234 of the core 212 at the inner surface 219 of the second barrier sheet 218, and each of the rows R, S, T, U, and V extends to the opposite edges 234A, 234B of the outer perimeter 234 of the core 212 between the first and second polymeric sheets 210, 211 with row R extending along and at the edge 234C and row V extending along and at the edge 234D, there are no unbonded portions of the polymeric sheets 210 and 211 that are not open to the outer perimeter 234 and therefore cut off from fluid communication with the gas in the interior cavity 221.

Because the first set of bonds 244 are at the areas 222A, 222B, 222C, 222D, and 222E, the first set of bonds 244 are linear bonds arranged in rows. Because the second set of bonds 244 are at the areas 213A, 213B, 213C, 213D, and 213E, the second set of bonds 244 are also linear bonds arranged in rows. Because the third set of bonds 247 are at the areas 215A, 215B, 215C, and 215D, the third set of bonds 247 are also linear bonds arranged in rows.

As is apparent in FIGS. 16-17, a thickness T4 of each of the polymeric sheets 210, 211 is not greater than a thickness T5 of the first barrier sheet 216 and is not greater than a thickness T6 of the second barrier sheet 218. Maintaining a sheet thickness of the polymeric sheets 210, 211 used in the core 212 not greater than that of the barrier sheets 216 and 218 helps to ensure the flexibility of the core 212 to function as a tether that easily collapses back toward the relatively flat state of FIG. 15 under compressive loading.

FIGS. 16-17 show that the tension created in the polymeric sheet 210 by the inflation of the interior cavity 221 causes portions of the first barrier sheet 216 inward of the outer perimeter 234 of the core 212 to be pulled downward at the bonds 244, as indicated by the contoured exterior surface 250 of the first barrier sheet 216. Because the outer perimeter 234 of the core 212 is entirely inward of the peripheral bond 238 and blocker ink 24 is disposed on one or both of the inner surfaces 217, 219 between the peripheral bond 238 and the outer perimeter 234, the barrier sheets 216, 218 will not be tethered together at a peripheral portion of the interior cavity 221 outward of the outer perimeter 234 of the core 212 and inward of the peripheral bond 238. The distance between the inner surfaces 217 and 219 and the resulting height of the cushioning component 214 may thus be greatest outward of the core 212.

Similarly, tension created in the polymeric sheet 211 by the inflation of the interior cavity 221 causes portions of the second barrier sheet 218 inward of the outer perimeter 234 of the core 12 to be pulled upward at the bonds 246, as indicated by the contoured exterior surface 252 of the second barrier sheet 218. The pattern of blocker ink 24 printed on the polymeric sheets 210, 211 and the resulting patterns of bonds of the polymeric sheets 210, 211 of the core 212 to the barrier sheets 216, 218 can be selected to control the resulting contours of the exterior surfaces 250, 252 of the barrier sheets 216, 218. The cushioning component 214 having the patterns of the first, second, and third sets of bonds, 244, 246, 247 may be referred to as a honeycomb cushioning component as at least some of the resulting adjacent channels through the core 212 at the linear rows of blocker ink 24 appear to have a hexagonal shape in cross-section, creating a look similar to honeycomb.

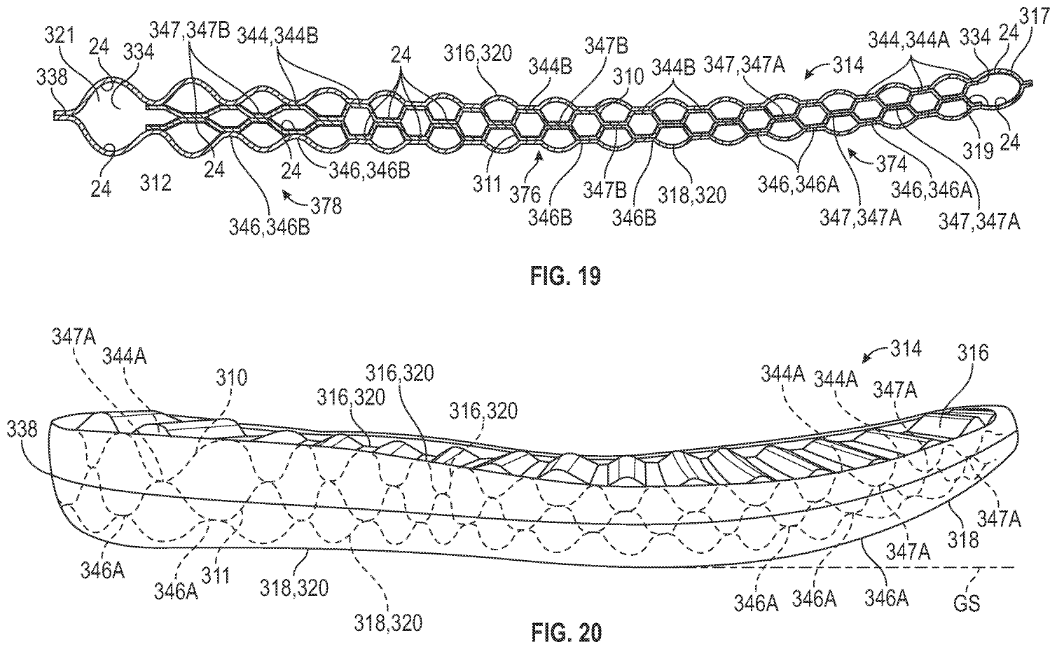

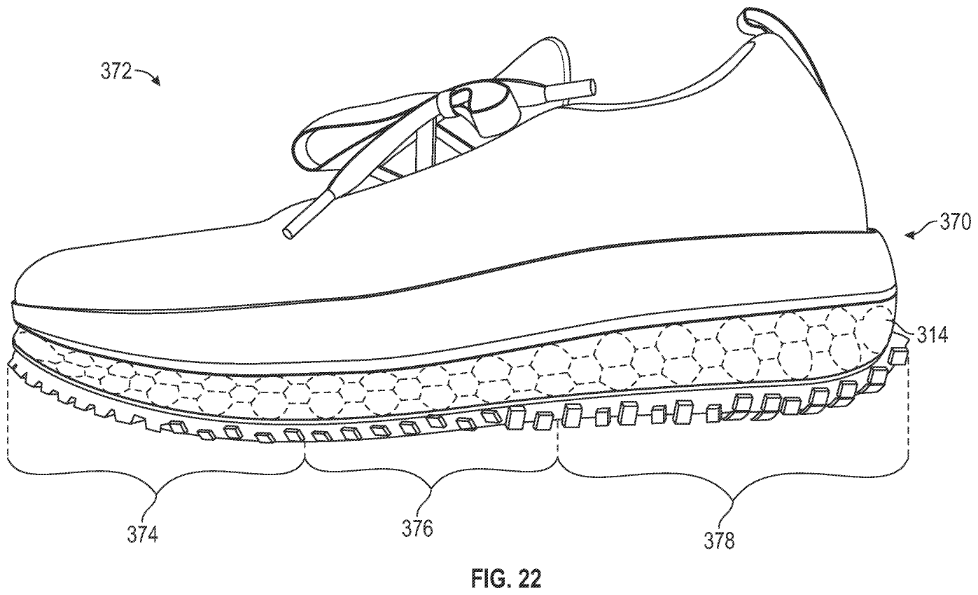

FIG. 18 is a perspective view showing the top and lateral side of a cushioning component 314. FIG. 19 is a cross-sectional view of the cushioning component 314 of FIG. 18 taken at lines 19-19 in FIG. 18 showing a core 312 with multiple polymeric sheets 310, 311 and bond patterns similar to those of the core 212 of FIG. 17. The cushioning component 314 is a midsole included in a sole structure 370 of an article of footwear 372 shown in lateral side view in FIG. 22. The cushioning component 314 and the article of footwear 372 include a forefoot region 374, a midfoot region 376, and a heel region 378. The cushioning component 314 and the article of footwear 372 also include a medial side 380 and a lateral side 382 (best shown in FIG. 18) opposite from the medial side 380.

The forefoot region 374 generally includes portions of the article of footwear 372 corresponding with the toes and the joints connecting the metatarsals with the phalanges of a wearer's foot. The midfoot region 376 generally includes portions of the article of footwear 372 corresponding with the arch area of the foot, and the heel region 378 corresponds with rear portions of the foot, including the calcaneus bone. The medial side 380 and the lateral side 382 extend through each of forefoot region 374, the midfoot region 376, and the heel region 378 and fall on opposite sides of a longitudinal midline LM of the article of footwear 372. The longitudinal midline LM is at the cross-sectional line of FIG. 19, as indicated in FIG. 18. The forefoot region 374, the midfoot region 376, the heel region 378, the medial side 380, and the lateral side 382 are not intended to demarcate precise areas of footwear 372 but are instead intended to represent general areas of footwear 372 to aid in the following discussion.

In addition to the core 312, the cushioning component 314 includes a bladder 320 having a first barrier sheet 316 and a second barrier sheet 318. Similar to the cushioning component 214, the first barrier sheet 316 is bonded to the first polymeric sheet 310 at a first set of bonds 344, the second barrier sheet 318 is bonded to the second polymeric sheet 311 at a second set of bonds 346, and the first polymeric sheet 310 is bonded to the second polymeric sheet 311 at a third set of bonds 347. The bonds 344, 346, and 347 are linear rows of bonds and result due to blocker ink 24 disposed on the first polymeric sheet 310 and the second polymeric sheet 311 in first, second, and third predetermined patterns, respectively, that are the same as those described with respect to the cushioning component 214 except that there are a greater number of rows of blocker ink and hence a greater number of linear bonds in each of the patterns of bonds in the cushioning component 314 than in the cushioning component 214. Only some of the bonds 344, 346, and 347 and some of the blocker ink 24 is indicated with reference numbers in FIG. 19. FIG. 20 is a slightly perspective view showing the medial side of the cushioning component of FIG. 18 with the first and second polymeric sheets 310, 311 shown in hidden lines.

The barrier sheets 316 and 318 are bonded to one another at a peripheral seam 338 to retain fluid within the interior cavity 321 defined between the barrier sheets 316, 318. An outer perimeter 334 of the core 312 is entirely inward of the peripheral seam 338, and blocker ink 24 is disposed on one or both of the inner surfaces 317, 319 of the barrier sheets 316, 318 inward of the peripheral bond 338 and outward of the outer perimeter 334 so that the barrier sheets 316, 318 do not bond to one another between the outer perimeter 334 and the peripheral seam 338.

These aspects and placement of the patterns of the blocker ink 24 relative to the outer perimeter 334 as well as placing the core 312 so that the entire outer perimeter 334 is entirely inward of the peripheral bond 338 ensures that the core 312 will tether the first and second barrier sheets 316 and 318 without creating any sealed chambers that are not in fluid communication with the interior cavity 321 defined between the opposing inner surfaces 317, 319 of the barrier sheets 316, 318. As described with respect to the core 212, the core 312 will collapse to return toward a flat state under dynamic compressive loading of the cushioning component 314 and thus acts as a tether to control and vary the distance between the inner surfaces of the barrier sheets 316, 318 without affecting the ability of the bladder 320 to compress under loading.

As is evident in FIG. 19, the plurality of bonds includes a first group of bonds in a first region of the bladder 320, such as the forefoot region 374, and a second group of bonds in a second region of the bladder 320, such as the midfoot region 376 or the heel region 378. The first group of bonds includes bonds 344A of the first set of bonds 344, bonds 346A of the second set of bonds 346, and bonds 347A of the third set of bonds 347. The second group of bonds includes bonds 344B of the first set of bonds 344, bonds 346B of the second set of bonds 346, and bonds 347B of the third set of bonds 347.

Spacing between adjacent bonds of the first group of bonds 344A, 346A, and 347A is less than spacing between adjacent bonds of the second group of bonds 344B, 346B, and 347B. Stated differently, two adjacent bonds 344A shown in the forefoot region 374 are closer to one another than are two adjacent bonds 344B in the midfoot region 376, for example, or two adjacent bonds 344B in the heel region 378. Likewise, two adjacent bonds 346A shown in the forefoot region 374 are closer to one another than are two adjacent bonds 346B in the midfoot region 376, for example, or two adjacent bonds 346B in the heel region 378. Still further, two adjacent bonds 347A shown in the forefoot region 374 are closer to one another than are two adjacent bonds 347B in the midfoot region 376, for example, or two adjacent bonds 347B in the heel region 378.

By placing adjacent bonds closer together in the forefoot region 374, the opposing inner surfaces 317 and 319 of the barrier sheets 316, 318 are held closer to one another by the polymeric sheets 310 and 311 in the first region (forefoot region 374) than in the second region (midfoot region 376 or heel region 378). This configuration results in toe spring, which is the gradual increasing elevation of the second barrier sheet 318 away from the ground surface GS in the forefoot region 374 in a forward direction when in a steady state position (e.g., unloaded or at least not under a dynamic compressive load) as shown in FIG. 20. This pre-shaping of the cushioning component 314 with a toe spring via the bond placement helps to create a forward foot roll and easier toe-off during a forward motion of the wearer.

In some embodiments, the spacing between the adjacent bonds of the first group of bonds progressively decreases from a rear of the first group of bonds to a front of the first group of bonds. In other words, the bonds 344A toward the rear of the forefoot region 374 are further apart than the bonds 344A toward the front of the forefoot region 374. Likewise, the bonds 346A toward the rear of the forefoot region 374 are further apart than the bonds 346A toward the front of the forefoot region 374, and the bonds 347A toward the rear of the forefoot region 374 are further apart than the bonds 347A toward the front of the forefoot region 374.

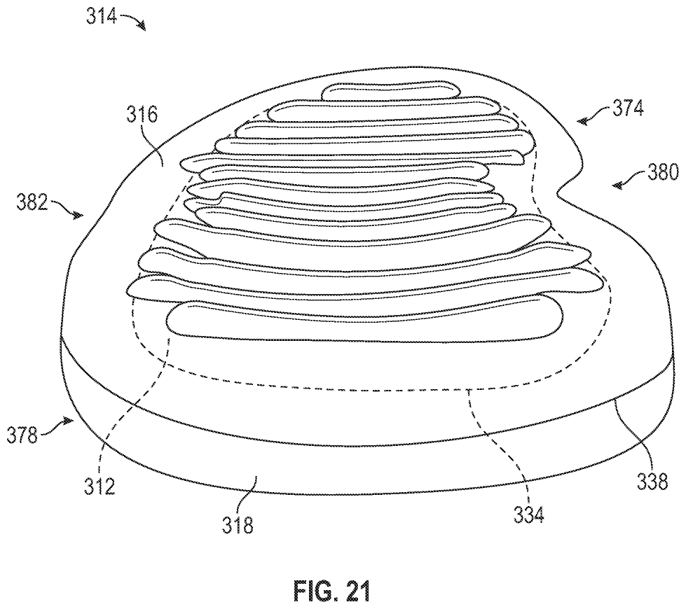

Referring to FIGS. 18 and 21, in addition to bond placement to promote toe spring, the outer perimeter 334 of the core 312 may be spaced further inward of the peripheral bond 338 in the heel region 378 than in the forefoot region 374. This creates a larger and taller peripheral portion of the interior cavity 321 around the core 312 in the heel region 378 than in the forefoot region 374, nesting the cushioning component 314 around the heel. As best shown in FIGS. 18 and 21, the first barrier sheet 316 may recess slightly downward between the medial side 380 and the lateral side 382 above the core 312 in the heel region 378, helping to cup the heel.

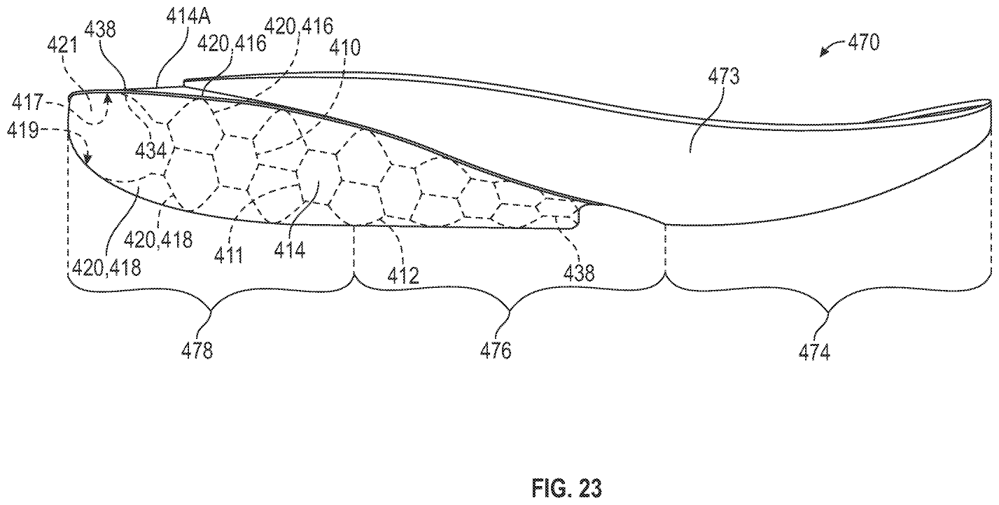

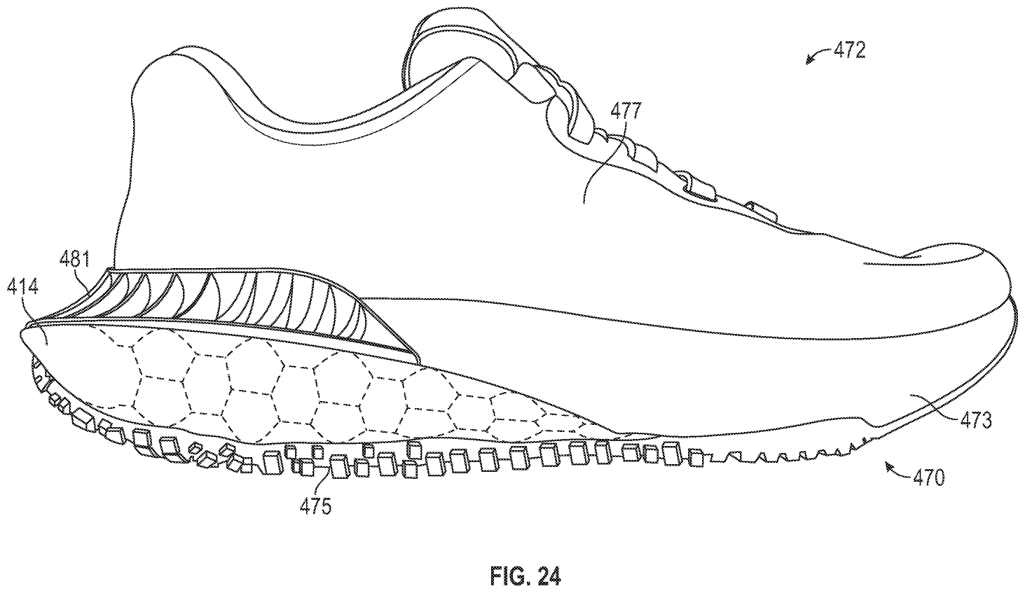

FIG. 23 is a lateral side view of another sole structure 470 for an article of footwear 472 shown in FIG. 24. The sole structure 470 includes a heel cushioning component 414 having a bladder 420 with first and second barrier sheets 416, 418 bonded to one another at a peripheral seam 438 to retain gas in an interior cavity 421 between opposing inner surface 417, 419 of the barrier sheets 416, 418. The heel cushioning component 414 includes a core 412 having multiple polymeric sheets 410, 411 disposed within the interior cavity 421. The heel cushioning component 414 has blocker ink 24 disposed on the polymeric sheets 410, 411 in linear rows and disposed on one or both of the inner surfaces 417, 419 outward of an outer perimeter 434 of the core 412 and inward of the peripheral seam 438 in a manner corresponding to that described with respect to the cushioning component 314 to result in a bond pattern similar to that of FIG. 19. The cushioning component 414 extends only in a heel region 478 and a midfoot region 476 of the sole structure 470, and fewer rows of blocker ink and resulting bonds are included than in the cushioning component 414. Like the cushioning component 414, spacing between adjacent rows of blocker ink may be closer toward a forward end of the cushioning component 414 than at a rearward end, so that the distance between the inner surfaces 417 and 419 is less toward the front than toward the rear of the cushioning component 414, as shown in FIG. 23.

A foam midsole layer 473 overlays the heel cushioning component 414 in a portion of the heel region 478 and in the midfoot region 476 and extends to the forefoot region 474. An upward-facing rear portion 414A of the heel cushioning component 414 is not overlain by the foam midsole layer 473.

FIG. 24 is a lateral side view of the article of footwear 472 including the sole structure 470 of FIG. 23. The sole structure 470 further includes an outsole 475 extending under the cushioning component 414 and the foam midsole layer 473 and establishing the ground contact surface of the article of footwear 472. The sole structure 470 is shown secured to a footwear upper 477 and a heel support 481 is shown extending around a rear of the footwear upper 477 and overlaying an exterior of the upward-facing rear portion 414A of the cushioning component 414 (indicated in FIG. 23) where the heel support 481 forms a ledge. The heel support 481 thus both protects the upward-facing rear portion 414A of the heel cushioning component 414 from direct wear and also forms a ledge at the rear of the article of footwear 472 that can be used for leverage in removing the article of footwear 472. For example, a wearer's opposite foot can be rested on the heel support 481 to provide leverage while the other foot is withdrawn from the footwear upper 477.

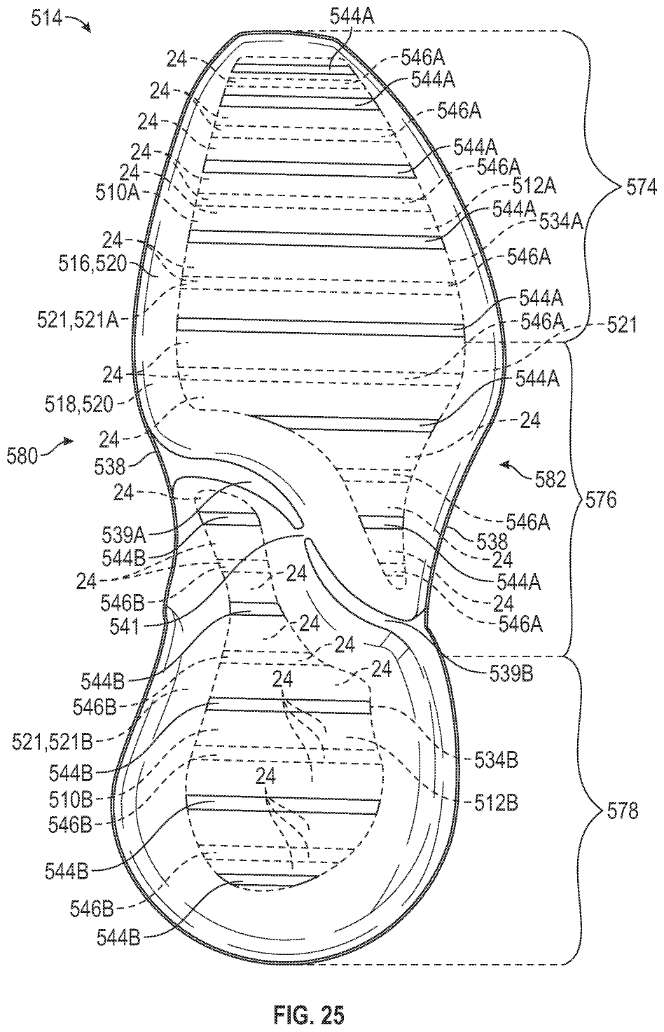

FIG. 25 is a plan view of an alternative embodiment of a cushioning component 514 for a wearable article, such as an article of footwear. The cushioning component 514 is configured as a midsole for a sole structure of an article of footwear and has a forefoot region 574, a midfoot region 576, and a heel region 578. The cushioning component 514 includes a forefoot core 512A having at least one polymeric sheet and a separate heel core 512B having at least one polymeric sheet. More specifically, the cushioning component 514 includes a bladder 520 that includes a first barrier sheet 516 (shown in the plan view of FIG. 25) and a second barrier sheet 518 (disposed below and hidden in the plan view of FIG. 25) sealed to one another along a peripheral bond 538 to enclose an interior cavity 521 and retain a gas in the interior cavity. The interior cavity 521 is disposed between opposing inner surfaces of the first barrier sheet 516 and the second barrier sheet 518 as described with respect to like components of the cushioning component 14.

The cores 512A and 512B are disposed in the interior cavity 521 and have respective outer perimeters 534A, 534B spaced entirely inward of the peripheral bond 538. A peripheral portion 521A of the interior cavity 521 outwardly surrounds each of the cores 512A, 512B between the peripheral bond 538 and the outer perimeters 534A, 534B.

Bonds 539A and 539B sealing the barrier sheets 516, 518 protrude inward from the peripheral bond 538 to partially separate the interior cavity 521, but fluid communication is permitted between a forward portion 521A of the interior cavity 521 around the front core 512A and a rearward portion 521B of the interior cavity 521 around the rear core 512B at a gap 541 between the bonds 539A, 539B.

The front core 512A includes a polymeric sheet 510A that traverses the interior cavity 521 between and is directly bonded to the opposing inner surfaces of the first barrier sheet 516 and the second barrier sheet 518 at a plurality of bonds to tether the first barrier sheet 516 to the second barrier sheet 518. The polymeric sheet 510A is displaced from the opposing inner surfaces of the barrier sheets 516, 518 by the gas at unbonded areas of the polymeric sheet 510A.

The rear core 512B includes a polymeric sheet 510B that traverses the interior cavity 521 between and is directly bonded to the opposing inner surfaces of the first barrier sheet 516 and the second barrier sheet 518 at a plurality of bonds to tether the first barrier sheet 516 to the second barrier sheet 518. The polymeric sheet 510B is displaced from the opposing inner surfaces by the gas at unbonded areas of the polymeric sheet 510B.

Blocker ink 24 is disposed on the front core 512A at the unbonded areas of the front core 512A and on the rear core 512B at the unbonded areas of the rear core 512B. As in the core 12, blocker ink 24 is disposed in spaced linear rows in alternating patterns on the opposing first and second sides of the polymeric sheet 510A, and in additional alternating patterns on opposing first and second sides of the polymeric sheet 510B. In addition to the areas marked in FIG. 25, blocker ink 24 also extends on the side of the polymeric sheets 510A and 510B facing the inner surface of the barrier sheet 516 directly over where the bonds 546A, 546B are on the opposing side, and blocker ink 24 extends on the side of the polymeric sheets 510A, 510B facing the inner surface of the barrier sheet 518 directly under where bonds 544A, 544B are on the opposing side. Blocker ink may also be disposed on one or both of the inner surfaces of the first and second barrier sheets 516, 518 between the peripheral bond 538 and outer perimeters 534A, 534B of the front and rear cores 512A, 512B.

More specifically, a first pattern of bonds 544A is formed at the interfacing areas of a first side (e.g., the top side in the plan view of FIG. 35) of the polymeric sheet 510A and the inner surface of the first barrier sheet 516 (e.g., where there is not blocker ink 24 between the first side and the inner surface). A second pattern of bonds 546A is formed at the interfacing areas of the second side of the polymeric sheet 510A and the inner surface of the second barrier sheet 518 (e.g., where there is not blocker ink 24 between the second side and the inner surface). The bonds 546A are offset from the bonds 544A. For clarity in the drawings, the bonds 544A to the top barrier sheet 516 are shown with solid lines in the plan view and the bonds 546A on the opposite barrier sheet 518 are shown with dashed lines.

Similarly, a first pattern of bonds 544B is formed at the interfacing areas of a first side (e.g., the top side in the plan view of FIG. 25) of the polymeric sheet 510B and the inner surface of the first barrier sheet 516 (e.g., where there is not blocker ink 24 between the first side and the inner surface). A second pattern of bonds 546B is formed at the interfacing areas of the second side of the polymeric sheet 510B and the inner surface of the second barrier sheet 518. The bonds 546B are offset from the bonds 544B. The blocker ink 24 prevents bonding at any interfacing areas where it is disposed. For clarity in the drawings, the bonds 544B to the top barrier sheet 516 are shown with solid lines in the plan view and the bonds 546B on the opposite barrier sheet 518 are shown with dashed lines.

The first and second cores 512A, 512B lay flat within the bladder 520 with the unbonded areas (areas at blocker ink 24) contacting the opposing inner surfaces when the interior cavity 521 of the bladder 520 is uninflated, and the polymeric sheets 510A, 510B are tensioned between the barrier sheets 516, 518 when the interior cavity 521 of the bladder 520 is inflated to control the height and outer contours of the bladder 520. Like the core 12, each of the polymeric sheets 510A, 510B will have a zig-zag orientation across the cavity 521 between the inner surface of the first barrier sheet 516 and the inner surface of the second barrier sheet 518.

With this arrangement of the patterns of bonds 544A, 544B, 546A, and 546B, gas in the interior cavity 521 is in fluid communication around the polymeric sheets 510A, 510B without the polymeric sheets 510A, 510B creating any sealed chambers within the bladder 520 that are not in fluid communication with the interior cavity 521.

In addition, spacing between adjacent bonds 544A and adjacent bonds 546A in the forefoot region 574 less than spacing between adjacent bonds 544A and adjacent bonds 546A in the midfoot region 576, and/or less than spacing between adjacent bonds 544B and adjacent bonds 546B in the heel region 578 to provide toe spring by causing the opposing inner surfaces of the barrier sheets 516, 518 to be held closer to one another by the polymeric sheet 510A in the forefoot region 574 than in the midfoot region 576 or heel region 578.

The outer perimeter 534B of the rear core 512B may be spaced further inward of the peripheral bond 538 in the heel region 378 than the outer perimeter 534A of the front core 512A is inward of the peripheral bond 538 in the forefoot region 574. This creates a larger and taller peripheral portion 521B of the interior cavity 521 around the rear core 512B in the heel region 578 than the peripheral portion 521A of the interior cavity 521 around the front core 512A in the forefoot region 574, nesting the cushioning component 514 around the heel, similar to as described with respect to cushioning component 314. Similar to the cushioning component 314, the bonds 544B, 546B may be configured so that the first barrier sheet 516 is recessed slightly downward over the heel core 512B between the medial side 580 and the lateral side 582 in the heel region 578, helping to cup the heel.

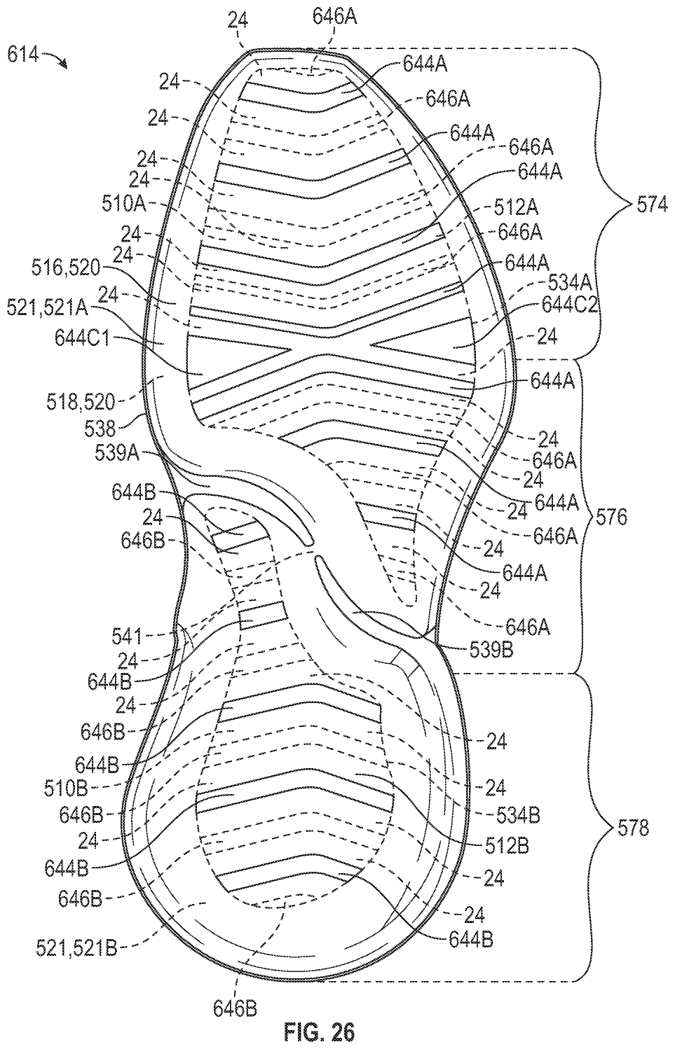

FIG. 26 is a plan view of another alternative embodiment of a cushioning component 614 alike in all aspects as the cushioning component 514 except a different pattern of bonds 644A, 644C1, 644C2, and 646A are used in place of bonds 544A, 546A, and a different pattern of bonds 644B, 646B are used in place of bonds 544B, 546B.

The bonds 644A, 644C1, and 644C2 bond the polymeric sheet 510A to the inner surface of the barrier sheet 516. Unlike bonds 544A which extend straight across the core 512A, the bonds 644A are V-shaped, extending outward from a vertex near a longitudinal centerline of the core 512A. Bonds 644C1 and 644C2 are also V-shaped, but each is disposed between two adjacent bonds 544A, and the bonds 644C1 and 644C2 extend outward from near the longitudinal centerline in opposite directions from one another.

Bonds 646A bond the opposite side of the polymeric sheet 510A to the inner surface of the barrier sheet 518 and are offset from the bonds 644A. The bonds 646A have V-shapes like those of bonds 644A. For clarity in the drawings, the bonds 644A, 644C1, and 644C2 bonding the polymeric sheet 510A to the top barrier sheet 516 are shown with solid lines in the plan view and the bonds 646A bonding the polymeric sheet 510A to the opposite barrier sheet 518 are shown with dashed lines.

Bonds 644B bond one side of the polymeric sheet 510B to the inner surface of the barrier sheet 516 and at least some are generally V-shaped, similar to bonds 644A. Bonds 646B bond the opposite side of the polymeric sheet 510B to the inner surface of the barrier sheet 518 and are offset from the bonds 644B. At least some of the bonds 646B have V-shapes like those of bonds 644A. For clarity in the drawings, the bonds 644B to the top barrier sheet 516 are shown with solid lines in the plan view and the bonds 646B to the opposite barrier sheet 518 are shown with dashed lines.

With this arrangement of the patterns of bonds 644A, 644B, 644C1, 644C2, 646A, and 646B, gas in the interior cavity 521 is in fluid communication around the polymeric sheets 510A, 510B without the polymeric sheets 510A, 510B creating any sealed chambers within the bladder 520 that are not in fluid communication with the interior cavity 521.

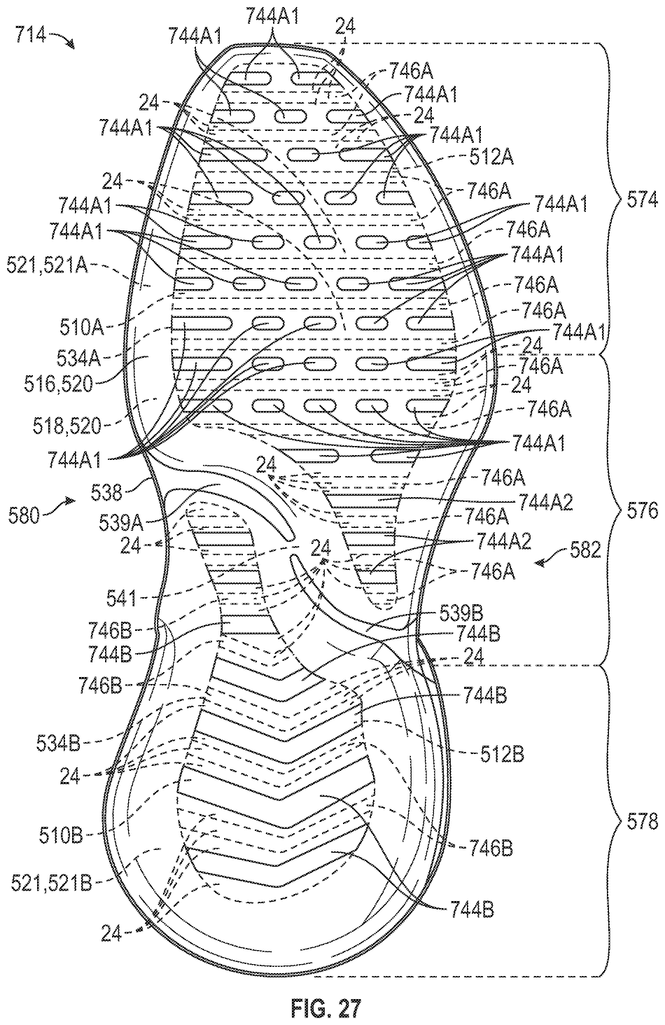

FIG. 27 is a plan view of another alternative embodiment of a cushioning component 714 alike in all aspects as the cushioning component 514 except a different pattern of bonds 744A1, 744A2, and 746A is used in place of bonds 544A, and 546A, and a different pattern of bonds 744B and 746B is used in place of bonds 544B, and 546B. The bonds 744A1 are referred to as dot bonds as they do not extend entirely across the core 512A from the outer perimeter 534A on the medial side 580 of the core 512A to the outer perimeter 534A or 534B on the lateral side 582 of the core 512A. The bonds 744A2 and 746A are referred to as linear bonds as they do extend entirely across the core 512A from the outer perimeter 534A or 534B on the medial side 580 to the outer perimeter 534A or 534B on the lateral side 582.

The bonds 744A1 and 744A2 bond a side of the polymeric sheet 510A to the inner surface of the barrier sheet 516. Similarly, bonds 744B bond the same side of the polymeric sheet 510B to the inner surface of the barrier sheet 516. Bonds 746A bond the opposite side of the polymeric sheet 510A to the inner surface of the barrier sheet 518 and are offset from the bonds 744A1 and 744A2. Bonds 746B bond the opposite side of the polymeric sheet 510B to the inner surface of the barrier sheet 518 and are offset from the bonds 744B.

With this arrangement of the patterns of bonds 744A1, 744A2, and 746A, and the patterns of bonds 744B and 746B, gas in the interior cavity 521 is in fluid communication around the polymeric sheets 510A, 510B without the polymeric sheets 510A, 510B creating any sealed chambers within the bladder 520 that are not in fluid communication with the interior cavity 521.

The following Clauses provide example configurations of a cushioning component for a wearable article disclosed herein.

Clause 1. A cushioning component for a wearable article, the cushioning component comprising: a bladder including a first barrier sheet and a second barrier sheet defining an interior cavity between opposing inner surfaces of the first barrier sheet and the second barrier sheet, the first barrier sheet and the second barrier sheet sealed to one another along a peripheral bond to enclose the interior cavity and retain a gas in the interior cavity; and a core disposed in the interior cavity and spaced entirely inward of the peripheral bond, the core including at least one polymeric sheet traversing the interior cavity between and directly bonded to the opposing inner surfaces of the first barrier sheet and the second barrier sheet at a plurality of bonds to tether the first barrier sheet to the second barrier sheet, the at least one polymeric sheet displaced from the opposing inner surfaces by the gas at unbonded areas of the at least one polymeric sheet, and the plurality of bonds arranged such that the gas in the interior cavity is in fluid communication around the at least one polymeric sheet without the at least one polymeric sheets creating any sealed chambers within the bladder that are not in fluid communication with the interior cavity.

Clause 2. The cushioning component of clause 1, wherein blocker ink is disposed on the core at the unbonded areas.

Clause 3. The cushioning component of any of clauses 1-2, wherein the core lays flat within the bladder with the unbonded areas contacting the opposing inner surfaces when the interior cavity of the bladder is uninflated.

Clause 4. The cushioning component of any of clauses 1-3, wherein a thickness of each polymeric sheet of the at least one polymeric sheet of the core is not greater than a thickness of the first barrier sheet and is not greater than a thickness of the second barrier sheet.

Clause 5. The cushioning component of any of clauses 1-4, wherein the plurality of bonds includes a first group of bonds in a first region of the bladder and a second group of bonds in a second region of the bladder; and wherein spacing between adjacent bonds of the first group of bonds is less than spacing between adjacent bonds of the second group of bonds such that the opposing inner surfaces are held closer to one another by the at least one polymeric sheet in the first region than in the second region.

Clause 6. The cushioning component of clause 5, wherein the wearable article is an article of footwear, the cushioning component is included in a sole structure of the article of footwear, the first group of bonds is in a forefoot region of the article of footwear and the second group of bonds is in one of a midfoot region or a heel region of the article of footwear.

Clause 7. The cushioning component of clause 6, wherein the spacing between the adjacent bonds of the first group of bonds progressively decreases from a rear of the first group of bonds to a front of the first group of bonds.

Clause 8. The cushioning component of clause 6, wherein an outer perimeter of the at least one polymeric sheet is spaced further inward of the peripheral bond in the heel region than in the forefoot region.

Clause 9. The cushioning component of any of clauses 1-4, wherein: the opposing inner surfaces of the bladder include a first inner surface of the first barrier sheet and a second inner surface of the second barrier sheet; the core is a single polymeric sheet having a first side bonded to the first inner surface of the first barrier sheet at a first set of bonds of the plurality of bonds and an opposing second side bonded to the second inner surface of the second barrier sheet at a second set of bonds of the plurality of bonds; and the second set of bonds is offset from the first set of bonds such that the bonds of the second set alternate with the bonds of the first set along a length of the single polymeric sheet.

Clause 10. The cushioning component of clause 9, wherein: the first set of bonds are linear bonds arranged in rows and the second set of bonds are linear bonds arranged in rows.

Clause 11. The cushioning component of clause 9, wherein: the first set of bonds are dot bonds arranged in rows and the second set of bonds are linear bonds arranged in rows, the rows.

Clause 12. The cushioning component of any of clauses 1-4, wherein: the opposing inner surfaces of the bladder include a first inner surface of the first barrier sheet and a second inner surface of the second barrier sheet; the core is a single polymeric sheet having a first side bonded to the first inner surface of the first barrier sheet at a first set of bonds of the plurality of bonds and an opposing second side bonded to the second inner surface of the second barrier sheet at a second set of bonds of the plurality of bonds; and the first set of bonds and the second set of bonds extend outward from a central region of the single polymeric sheet in an array with the bonds of the second set alternating with the bonds of the first set around the central region.

Clause 13. The cushioning component of any of clauses 1-4, wherein: the opposing inner surfaces of the bladder include a first inner surface of the first barrier sheet and a second inner surface of the second barrier sheet; the at least one polymeric sheet of the core includes a first polymeric sheet and a second polymeric sheet, the first polymeric sheet disposed between the first barrier sheet and the second polymeric sheet, and the second polymeric sheet disposed between the first polymeric sheet and the second barrier sheet such that a first side of the first polymeric sheet faces the first inner surface of the first barrier sheet, a second side of the first polymeric sheet faces a first side of the second polymeric sheet, and a second side of the second polymeric sheet faces the second inner surface of the second barrier sheet; and the first polymeric sheet having the first side directly bonded to the first inner surface of the first barrier sheet at a first set of bonds of the plurality of bonds, the second polymeric sheet having the second side directly bonded to the second inner surface of the second barrier sheet at a second set of bonds of the plurality of bonds, the second side of the first polymeric sheet bonded to the first side of the second polymeric sheet at a third set of bonds of the plurality of bonds, the bonds of the third set alternating with the bonds of the first set along a length of the first polymeric sheet, and the bonds of the third set alternating with the bonds of the second set along a length of the second polymeric sheet.

Clause 14. The cushioning component of clause 13, wherein the second set of bonds is aligned with the first set of bonds.

Clause 15. The cushioning component of clause 13, wherein at least some of the bonds of the plurality of bonds are linear bonds.

Clause 16. The cushioning component of any of clauses 1-4, wherein at least some of the bonds of the plurality of bonds are dot bonds.

Clause 17. The cushioning component of clause 16, wherein the dot bonds are arranged in rows with the dot bonds of adjacent ones of the rows offset from one another.

Clause 18. The cushioning component of any of clauses 1-4, wherein the plurality of bonds includes linear bonds arranged in rows and dot bonds arranged in rows, the rows of the dot bonds alternating with the rows of linear bonds.

To assist and clarify the description of various embodiments, various terms are defined herein. Unless otherwise indicated, the following definitions apply throughout this specification (including the claims). Additionally, all references referred to are incorporated herein in their entirety.

An “article of footwear”, a “footwear article of manufacture”, and “footwear” may be considered to be both a machine and a manufacture. Assembled, ready to wear footwear articles (e.g., shoes, sandals, boots, etc.), as well as discrete components of footwear articles (such as a midsole, an outsole, an upper component, etc.) prior to final assembly into ready-to-wear footwear articles, are considered and alternatively referred to herein in either the singular or plural as “article(s) of footwear”.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

The term “longitudinal” particularly refers to a direction extending a length of a component. For example, a longitudinal direction of a shoe extends between a forefoot region and a heel region of the shoe. The term “forward” or “anterior” is used to particularly refer to the general direction from a heel region toward a forefoot region, and the term “rearward” or “posterior” is used to particularly refer to the opposite direction, i.e., the direction from the forefoot region toward the heel region. In some cases, a component may be identified with a longitudinal axis as well as a forward and rearward longitudinal direction along that axis. The longitudinal direction or axis may also be referred to as an anterior-posterior direction or axis.

The term “transverse” particularly refers to a direction extending a width of a component. For example, a transverse direction of a shoe extends between a lateral side and a medial side of the shoe. The transverse direction or axis may also be referred to as a lateral direction or axis or a mediolateral direction or axis.

The term “vertical” particularly refers to a direction generally perpendicular to both the lateral and longitudinal directions. For example, in cases where a sole is planted flat on a ground surface, the vertical direction may extend from the ground surface upward. It will be understood that each of these directional adjectives may be applied to individual components of a sole. The term “upward” or “upwards” particularly refers to the vertical direction pointing towards a top of the component, which may include an instep, a fastening region and/or a throat of an upper. The term “downward” or “downwards” particularly refers to the vertical direction pointing opposite the upwards direction, toward the bottom of a component and may generally point towards the bottom of a sole structure of an article of footwear.

The “interior” of an article of footwear, such as a shoe, particularly refers to portions at the space that is occupied by a wearer's foot when the shoe is worn. The “inner side” of a component particularly refers to the side or surface of the component that is (or will be) oriented toward the interior of the component or article of footwear in an assembled article of footwear. The “outer side” or “exterior” of a component particularly refers to the side or surface of the component that is (or will be) oriented away from the interior of the shoe in an assembled shoe. In some cases, other components may be between the inner side of a component and the interior in the assembled article of footwear. Similarly, other components may be between an outer side of a component and the space external to the assembled article of footwear. Further, the terms “inward” and “inwardly” particularly refer to the direction toward the interior of the component or article of footwear, such as a shoe, and the terms “outward” and “outwardly” particularly refer to the direction toward the exterior of the component or article of footwear, such as the shoe. In addition, the term “proximal” particularly refers to a direction that is nearer a center of a footwear component, or is closer toward a foot when the foot is inserted in the article of footwear as it is worn by a user. Likewise, the term “distal” particularly refers to a relative position that is further away from a center of the footwear component or is further from a foot when the foot is inserted in the article of footwear as it is worn by a user. Thus, the terms proximal and distal may be understood to provide generally opposing terms to describe relative spatial positions.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

While several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A cushioning component for a wearable article, the cushioning component comprising:
a bladder including a first barrier sheet and a second barrier sheet defining an interior cavity between opposing inner surfaces of the first barrier sheet and the second barrier sheet, the first barrier sheet and the second barrier sheet sealed to one another along a peripheral bond to enclose the interior cavity and retain a gas in the interior cavity; and
a core disposed in the interior cavity and spaced entirely inward of the peripheral bond, the core including at least one polymeric sheet traversing the interior cavity between and directly bonded to the opposing inner surfaces of the first barrier sheet and the second barrier sheet at a plurality of bonds to tether the first barrier sheet to the second barrier sheet, the at least one polymeric sheet displaced from the opposing inner surfaces by the gas at unbonded areas of the at least one polymeric sheet, and the plurality of bonds arranged such that the gas in the interior cavity is in fluid communication around the at least one polymeric sheet without the at least one polymeric sheets creating any sealed chambers within the bladder that are not in fluid communication with the interior cavity.

2. The cushioning component of claim 1, wherein blocker ink is disposed on the core at the unbonded areas.

3. The cushioning component of claim 1, wherein the core lays flat within the bladder with the unbonded areas contacting the opposing inner surfaces when the interior cavity of the bladder is uninflated.

4. The cushioning component of claim 1, wherein a thickness of each polymeric sheet of the at least one polymeric sheet of the core is not greater than a thickness of the first barrier sheet and is not greater than a thickness of the second barrier sheet.

5. The cushioning component of claim 1, wherein the plurality of bonds includes a first group of bonds in a first region of the bladder and a second group of bonds in a second region of the bladder; and
wherein spacing between adjacent bonds of the first group of bonds is less than spacing between adjacent bonds of the second group of bonds such that the opposing inner surfaces are held closer to one another by the at least one polymeric sheet in the first region than in the second region.

6. The cushioning component of claim 5, wherein the wearable article is an article of footwear, the cushioning component is included in a sole structure of the article of footwear, the first group of bonds is in a forefoot region of the article of footwear and the second group of bonds is in one of a midfoot region or a heel region of the article of footwear.

7. The cushioning component of claim 6, wherein the spacing between the adjacent bonds of the first group of bonds progressively decreases from a rear of the first group of bonds to a front of the first group of bonds.

8. The cushioning component of claim 6, wherein an outer perimeter of the at least one polymeric sheet is spaced further inward of the peripheral bond in the heel region than in the forefoot region.

9. The cushioning component of claim 1, wherein:
the opposing inner surfaces of the bladder include a first inner surface of the first barrier sheet and a second inner surface of the second barrier sheet;
the core is a single polymeric sheet having a first side bonded to the first inner surface of the first barrier sheet at a first set of bonds of the plurality of bonds and an opposing second side bonded to the second inner surface of the second barrier sheet at a second set of bonds of the plurality of bonds; and
the second set of bonds is offset from the first set of bonds such that the bonds of the second set alternate with the bonds of the first set along a length of the single polymeric sheet.

10. The cushioning component of claim 9, wherein:
the first set of bonds are linear bonds arranged in rows and the second set of bonds are linear bonds arranged in rows.

11. The cushioning component of claim 9, wherein:
the first set of bonds are dot bonds arranged in rows and the second set of bonds are linear bonds arranged in rows, the rows.

12. The cushioning component of claim 1, wherein:
the opposing inner surfaces of the bladder include a first inner surface of the first barrier sheet and a second inner surface of the second barrier sheet;
the core is a single polymeric sheet having a first side bonded to the first inner surface of the first barrier sheet at a first set of bonds of the plurality of bonds and an opposing second side bonded to the second inner surface of the second barrier sheet at a second set of bonds of the plurality of bonds; and
the first set of bonds and the second set of bonds extend outward from a central region of the single polymeric sheet in an array with the bonds of the second set alternating with the bonds of the first set around the central region.

13. The cushioning component of claim 1, wherein:
the opposing inner surfaces of the bladder include a first inner surface of the first barrier sheet and a second inner surface of the second barrier sheet;
the at least one polymeric sheet of the core includes a first polymeric sheet and a second polymeric sheet, the first polymeric sheet disposed between the first barrier sheet and the second polymeric sheet, and the second polymeric sheet disposed between the first polymeric sheet and the second barrier sheet such that a first side of the first polymeric sheet faces the first inner surface of the first barrier sheet, a second side of the first polymeric sheet faces a first side of the second polymeric sheet, and a second side of the second polymeric sheet faces the second inner surface of the second barrier sheet; and
the first polymeric sheet having the first side directly bonded to the first inner surface of the first barrier sheet at a first set of bonds of the plurality of bonds, the second polymeric sheet having the second side directly bonded to the second inner surface of the second barrier sheet at a second set of bonds of the plurality of bonds, the second side of the first polymeric sheet bonded to the first side of the second polymeric sheet at a third set of bonds of the plurality of bonds, the bonds of the third set alternating with the bonds of the first set along a length of the first polymeric sheet, and the bonds of the third set alternating with the bonds of the second set along a length of the second polymeric sheet.

14. The cushioning component of claim 13, wherein the second set of bonds is aligned with the first set of bonds.

15. The cushioning component of claim 13, wherein at least some of the bonds of the plurality of bonds are linear bonds.

16. The cushioning component of claim 1, wherein at least some of the bonds of the plurality of bonds are dot bonds.

17. The cushioning component of claim 16, wherein the dot bonds are arranged in rows with the dot bonds of adjacent ones of the rows offset from one another.

18. The cushioning component of claim 1, wherein the plurality of bonds includes linear bonds arranged in rows and dot bonds arranged in rows, the rows of the dot bonds alternating with the rows of linear bonds.
